(19) United States
(12) Patent Application Publication
(10) Pub. No.: US 2023/0018898 A1
(43) Pub. Date: Jan. 19, 2023

(54) LIQUID DISCHARGE HEAD UNIT AND LIQUID DISCHARGE DEVICE

(71) Applicant: SEIKO EPSON CORPORATION, Tokyo (JP)

(72) Inventors: Noritaka IDE, Shiojiri-shi, (JP); Shoichiro YOKOO, Matsumoto-shi, (JP); Eiju HIRAI, Azumino-shi (JP); Yu SHIOZAWA, Shiojiri-shi (JP); Masaki MORI, Shiojiri-shi (JP)

(21) Appl. No.: 17/812,314

(22) Filed: Jul. 13, 2022

(30) Foreign Application Priority Data
Jul. 14, 2021 (JP) 2021-116440

(51) Int. Cl. B41J 2/14; B41J 2/045

(52) U.S. Cl. CPC B41J 2/14201; B41J 2/04548

(57) ABSTRACT

A liquid discharge head unit includes a liquid discharge head that has a first detection resistor that is provided to correspond to a first piezoelectric element group, a second detection resistor that is provided to correspond to a second piezoelectric element group, a power supply circuit that causes a current to flow through the first detection resistor and the second detection resistor, a voltage detection circuit that detects a voltage, and a switching circuit that is configured to switch between a first state in which the voltage detection circuit is configured to detect a voltage generated in the first detection resistor due to the current flowing from the power supply circuit and a second state in which the voltage detection circuit is configured to detect a voltage generated in the second detection resistor due to the current flowing from the power supply circuit.

The present application is based on, and claims priority from JP Application Serial Number 2021-116440, filed Jul. 14, 2021, the disclosure of which is hereby incorporated by reference herein in its entirety.

### BACKGROUND

### 1. Technical Field

The present disclosure relates to a liquid discharge head unit and a liquid discharge device.

### 2. Related Art

Described is a printer that changes the number of maintenance drive pulses applied to a piezoelectric element based on an environmental temperature detected by a temperature detection section provided on a side surface of a carriage on which a liquid discharge head is mounted.

JP-A-2011-104916 is an example of the related art.

In a liquid discharge head provided with a piezoelectric element, a temperature of ink in a pressure chamber may not be accurately detected when a temperature detection section is provided outside the liquid discharge head. Therefore, there is a demand for disposing the temperature detection section in the liquid discharge head. However, when the temperature detection section is simply disposed inside the liquid discharge head, a wiring for transmitting a detection result of the temperature detection section becomes long, so that there is a problem that a size of the liquid discharge head becomes large or measurement accuracy deteriorates due to an influence of noise.

### SUMMARY

The present disclosure can be realized in the following aspects.

According to a first aspect of the present disclosure, there is provided a liquid discharge head unit. According to an aspect of the present disclosure, there is provided a liquid discharge head unit including a liquid discharge head that has a plurality of pressure chambers, a plurality of piezoelectric elements, and a drive wiring for applying a voltage for driving the piezoelectric elements to the piezoelectric elements, a first detection resistor that is provided to correspond to a first piezoelectric element group among the plurality of piezoelectric elements, and formed of the same material as the piezoelectric elements or the drive wiring, a second detection resistor that is provided to correspond to a second piezoelectric element group different from the first piezoelectric element group among the plurality of piezoelectric elements, and formed of the same material as the piezoelectric elements or the drive wiring, a power supply circuit that causes a current to flow through the first detection resistor and the second detection resistor, a voltage detection circuit that detects a voltage, and a switching circuit that is configured to switch between a first state in which the voltage detection circuit is configured to detect a voltage generated in the first detection resistor due to the current flowing from the power supply circuit and a second state in which the voltage detection circuit is configured to detect a voltage generated in the second detection resistor due to the current flowing from the power supply circuit.

According to a second aspect of the present disclosure, there is provided a liquid discharge device. The liquid discharge device includes a liquid discharge head unit according to the first aspect and a control section that controls a discharge operation of the liquid discharge head unit.

### BRIEF DESCRIPTION OF THE DRAWINGS

FIG. 1 is an explanatory diagram showing a schematic configuration of a liquid discharge device as a first embodiment.

FIG. 2 is an exploded perspective view showing a configuration of a liquid discharge head.

FIG. 3 is an explanatory diagram showing a configuration of a liquid discharge head in a plan view.

FIG. 4 is a cross-sectional view showing an IV-IV position of FIG. 3.

FIG. 5 is an enlarged cross-sectional view showing the vicinity of a piezoelectric element.

FIG. 6 is a cross-sectional view showing a VI-VI position of FIG. 3.

FIG. 7 is a block diagram showing a functional configuration of the liquid discharge device.

FIG. 8 is a block diagram showing a functional configuration of a liquid discharge head unit.

FIG. 9 is an explanatory diagram showing a circuit configuration of a temperature detection circuit.

FIG. 10 is an explanatory diagram showing a temperature detection circuit included in a liquid discharge head unit of a second embodiment.

FIG. 11 is an explanatory diagram showing a circuit configuration of a power supply circuit of a temperature detection circuit.

### DESCRIPTION OF EXEMPLARY EMBODIMENTS

### A. First Embodiment

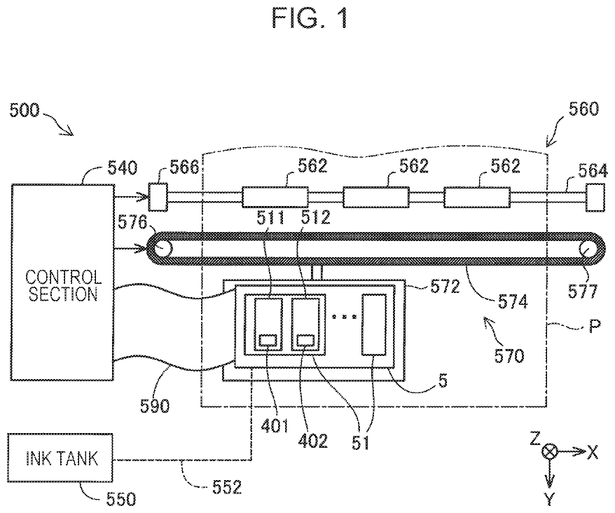

FIG. 1 is an explanatory diagram showing a schematic configuration of a liquid discharge device 500 as a first embodiment of the present disclosure. In the present embodiment, the liquid discharge device 500 is an ink jet printer that discharges ink as an example of a liquid onto printing paper P to form an image. The liquid discharge device 500 may use any kind of medium, such as a resin film or a cloth, as an ink discharge target, instead of the printing paper P. X, Y, and Z shown in FIG. 1 and each drawings subsequent to FIG. 1 represent three spatial axes orthogonal to each other. In the present specification, directions along the axes are also referred to as an X-axis direction, a Y-axis direction, and a Z-axis direction. When specifying the direction, a positive direction is “+” and a negative direction is “−” so that positive and negative signs are used together in the direction notation, and description will be performed while a direction to which an arrow faces in each figure is the + direction and an opposite direction thereof is the − direction. In the present embodiment, the Z direction coincides with a vertical direction, the +Z direction indicates vertically downward, and the −Z direction indicates vertically upward. Further, when the positive direction and the negative direction are not limited, the three X, Y, and Z will be described as the X axis, the Y axis, and the Z axis.

As shown in FIG. 1, the liquid discharge device 500 includes a print head 5, an ink tank 550, a transport mechanism 560, a moving mechanism 570, and a control section 540. A signal or the like for controlling the discharge of the ink is supplied to the print head 5 from the control section 540 via a cable 590. The print head 5 discharges the ink supplied from the ink tank 550 at the amount and timing according to the signal supplied from the control section 540. The print head 5 includes a liquid discharge head unit 51 of the present embodiment and a circuit substrate which will be described later. Although not shown in FIG. 1, in the present embodiment, the print head 5 includes a plurality of liquid discharge head units 51. In the example of FIG. 1, each liquid discharge head unit 51 is provided with two liquid discharge heads, that is, a first liquid discharge head 511 and a second liquid discharge head 512. The number of liquid discharge head units 51 is not limited to the plural and may be the singular.

In the present embodiment, a configuration of the first liquid discharge head 511 is the same as a configuration of the second liquid discharge head 512. In the following description, when the first liquid discharge head 511 and the second liquid discharge head 512 are not distinguished, the first liquid discharge head 511 and the second liquid discharge head 512 are referred to as a liquid discharge head 510. There is a case where a pressure chamber 12 provided in the first liquid discharge head 511 is referred to as a first pressure chamber, a piezoelectric element 300 is referred to as a first piezoelectric element, a drive wiring is referred to as a first drive wiring, and a detection resistor 401 is referred to as a first detection resistor 401, respectively. There is a case where a pressure chamber 12 provided in the second liquid discharge head 512 is referred to as a second pressure chamber, a piezoelectric element 300 is referred to as a second piezoelectric element, a drive wiring is a second drive wiring, and a detection resistor 402 is referred to as a second detection resistor 402, respectively. However, the configurations of the first liquid discharge head 511 and the second liquid discharge head 512 are not limited to the same cases, and may be different from each other.

The liquid discharge head 510 discharges inks of a total of four colors, for example, black, cyan, magenta, and yellow, from the nozzles in the +Z direction to form an image on the printing paper P. The first liquid discharge head 511 reciprocates in a main scanning direction with the movement of a carriage 572. In the present embodiment, the main scanning directions are the +X direction and the −X direction. The liquid discharge head 510 may discharge ink of a random color such as light cyan, light magenta, or white, while not being limited to the four colors.

The ink tank 550 functions as a liquid accommodation section for accommodating ink. The ink tank 550 is coupled to the print head 5 by a resin tube 552, and the ink of the ink tank 550 is supplied to the print head 5 via the tube 552. The ink supplied to the print head 5 is supplied to each liquid discharge head 510. Instead of the ink tank 550, a bag-shaped liquid pack made of a flexible film may be provided.

The transport mechanism 560 transports the printing paper P in a sub-scanning direction. The sub-scanning direction is a direction that intersects the X-axis direction, which is a main scanning direction, and is the +Y direction and the −Y direction in the present embodiment. The transport mechanism 560 includes a transport rod 564, on which three transport rollers 562 are mounted, and a transport motor 566 for rotatably driving the transport rod 564. When the transport motor 566 rotatably drives the transport rod 564, the printing paper P is transported in the +Y direction, which is the sub-scanning direction. The number of the transport rollers 562 is not limited to three and may be a random number. Further, a configuration, in which a plurality of transport mechanisms 560 are provided, may be provided.

The moving mechanism 570 includes a carriage 572, a transport belt 574, a moving motor 576, and a pulley 577. The carriage 572 is mounted with the print head 5 in a state where ink can be discharged. The carriage 572 is fixed to the transport belt 574. The transport belt 574 is bridged between the moving motor 576 and the pulley 577. When the moving motor 576 is rotatably driven, the transport belt 574 reciprocates in the main scanning direction. As a result, the carriage 572 fixed to the transport belt 574 also reciprocates in the main scanning direction.

The control section 540 controls the entire liquid discharge device 500. The control section 540 controls, for example, a reciprocating operation of the carriage 572 along the main scanning direction, a transport operation of the printing paper P along the sub-scanning direction, and a discharge operation of the liquid discharge head 510. The control section 540 also functions as a drive control section for the piezoelectric element 300. In the present embodiment, the control section 540 can further detect the temperature of the pressure chamber 12 by the detection resistor 401 provided in the liquid discharge head 510. The control section 540 controls the discharge of ink to the printing paper P by outputting a drive signal based on the detected temperature of the pressure chamber 12 to the liquid discharge head 510 and driving the piezoelectric element 300. In the present embodiment, the control section 540 stores in advance the correspondence relationship between an electric resistance value and the temperature of the detection resistor 401 in the storage circuit. The control section 540 may be composed of, for example, one or a plurality of processing circuits such as a Central Processing Unit (CPU) or a Field Programmable Gate Array (FPGA), and one or a plurality of storage circuits such as a semiconductor memory.

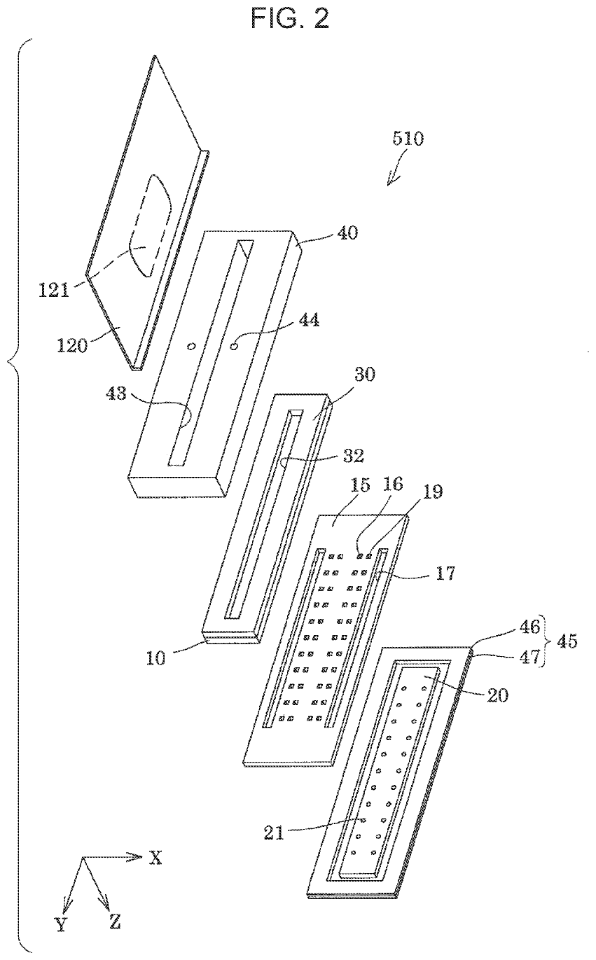

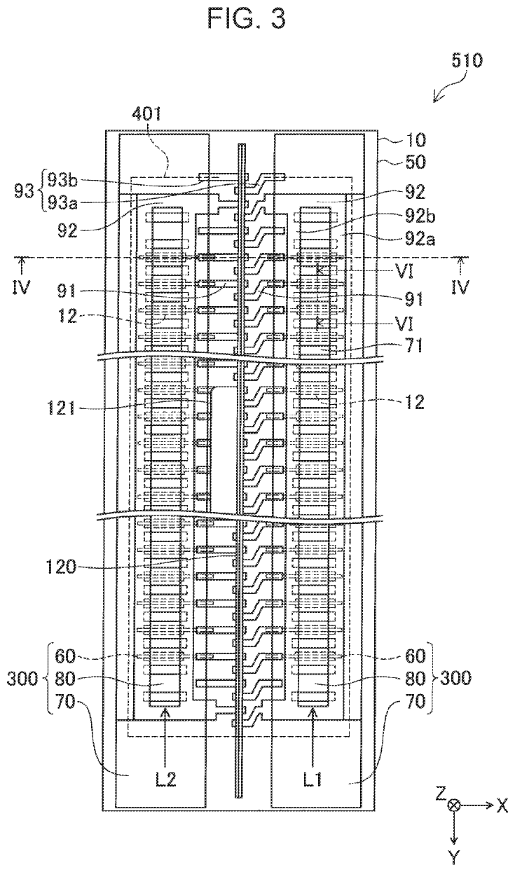

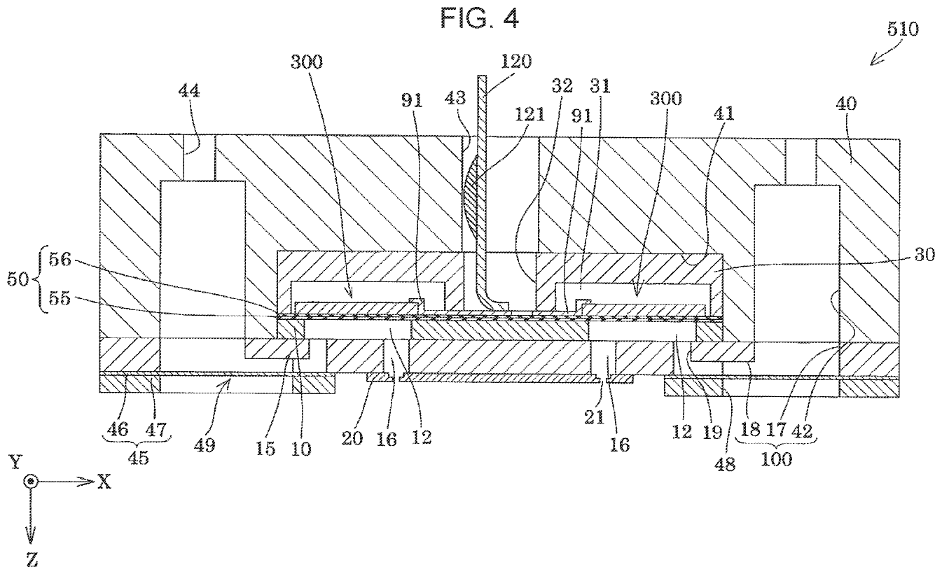

A detailed configuration of the liquid discharge head 510 will be described with reference to FIGS. 2 to 4. FIG. 2 is an exploded perspective view showing the configuration of the liquid discharge head 510. FIG. 3 is an explanatory diagram showing the configuration of the liquid discharge head 510 in a plan view. FIG. 3 shows a configuration around a pressure chamber substrate 10 in the liquid discharge head 510. In FIG. 3, a protective substrate 30 and a case member 40 are omitted for easy understanding of the technique. FIG. 4 is a cross-sectional view showing an IV-IV position of FIG. 3.

As shown in FIG. 2, the liquid discharge head 510 includes a pressure chamber substrate 10, a communication plate 15, a nozzle plate 20, a compliance substrate 45, a protective substrate 30, a case member 40, and a relay substrate 120. Further, the liquid discharge head 510 includes a piezoelectric element 300 shown in FIG. 3 and a diaphragm 50 shown in FIG. 4. The pressure chamber substrate 10, the communication plate 15, the nozzle plate 20, the compliance substrate 45, the diaphragm 50, the piezoelectric element 300, the protective substrate 30, and the case member 40 are laminated members, and the liquid discharge head 510 is formed by laminating the laminated members. In the present disclosure, a direction in which the laminated members forming the liquid discharge head 510 are laminated is also referred to as a “lamination direction”.

The pressure chamber substrate 10 is formed by using, for example, a silicon substrate, a glass substrate, an SOI substrate, various ceramic substrates, and the like. As shown in FIG. 3, a plurality of pressure chambers 12 are arranged in the pressure chamber substrate 10 along a predetermined direction in the pressure chamber substrate 10. The direction in which the plurality of pressure chambers 12 are arranged is also referred to as an “arrangement direction”. The pressure chamber 12 is formed in a rectangular shape in which a length in the X-axis direction is longer than a length in the Y-axis direction in a plan view. The shape of the pressure chamber 12 is not limited to the rectangular shape, and may be a parallelogram shape, a polygonal shape, a circular shape, an oval shape, or the like. The oval shape referred to here is a shape in which both end portions in a longitudinal direction are semicircular based on a rectangular shape, and includes a rounded rectangular shape, an elliptical shape, an egg shape, and the like.

In the present embodiment, the plurality of pressure chambers 12 are arranged in two rows each having the Y-axis direction as the arrangement direction. In the example of FIG. 3, the pressure chamber substrate 10 is formed with two pressure chamber rows, that is, a first pressure chamber row L1 having the Y-axis direction as the arrangement direction and a second pressure chamber row L2 having the Y-axis direction as the arrangement direction. The second pressure chamber row L2 is arranged to be adjacent to the first pressure chamber row L1 in a direction intersecting the arrangement direction of the first pressure chamber row L1. The direction intersecting the arrangement direction is also referred to as an “intersection direction”. In the example of FIG. 3, the intersection direction is the X-axis direction, and the second pressure chamber row L2 is adjacent to the −X direction of the first pressure chamber row L1. The arrangement direction means a macroscopic arrangement direction of the plurality of pressure chambers 12. For example, when a plurality of pressure chambers 12 are arranged along the Y-axis direction according to a so-called staggered arrangement in which every other pressure chamber 12 is alternately disposed in the intersection direction, the Y-axis direction is included in the arrangement direction.

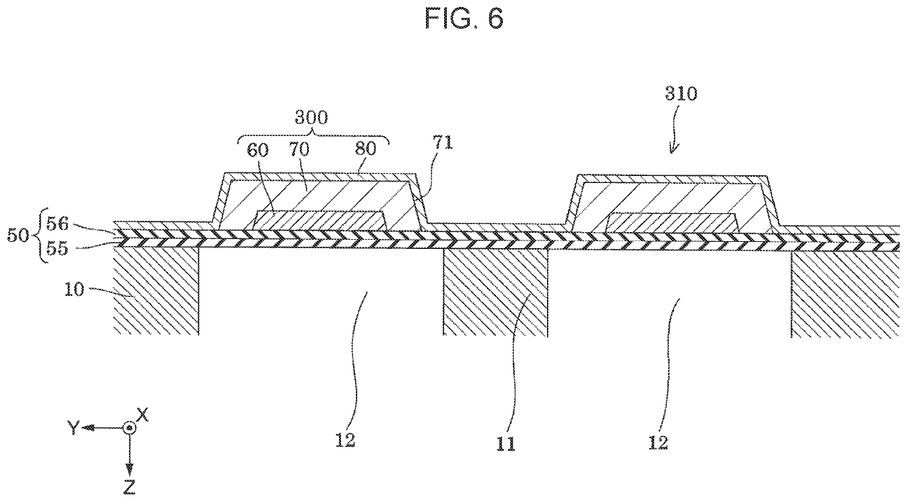

The plurality of pressure chambers 12 belonging to the first pressure chamber row L1 and the plurality of pressure chambers 12 belonging to the second pressure chamber row L2 have positions which are respectively coincide with each other in the arrangement direction, and are disposed to be adjacent to each other in the intersection direction. In each pressure chamber row, the pressure chambers 12 adjacent to each other in the Y-axis direction are partitioned by a partition wall 11 shown in FIG. 6, as will be described later.

As shown in FIG. 2, the communication plate 15, the nozzle plate 20, and the compliance substrate 45 are laminated in order on the +Z direction side of the pressure chamber substrate 10. The communication plate 15 is, for example, a flat plate member using a silicon substrate, a glass substrate, an SOI substrate, various ceramic substrates, a metal substrate, or the like. Examples of the metal substrate include a stainless steel substrate or the like. As shown in FIG. 4, the communication plate 15 is provided with a nozzle communication path 16, a first manifold portion 17, a second manifold portion 18, and a supply communication path 19. It is preferable that the communication plate 15 is formed by using a material having a thermal expansion coefficient substantially the same as a thermal expansion coefficient of the pressure chamber substrate 10. As a result, when the temperatures of the pressure chamber substrate 10 and the communication plate 15 change, it is possible to suppress the warp of the pressure chamber substrate 10 and the communication plate 15 due to a difference in the thermal expansion coefficient.

As shown in FIG. 4, the nozzle communication path 16 is a flow path that communicates the pressure chamber 12 and a nozzle 21. The first manifold portion 17 and the second manifold portion 18 function as a part of a manifold 100 which is a common liquid chamber in which a plurality of pressure chambers 12 communicate with each other. The first manifold portion 17 is provided to penetrate the communication plate 15 in the Z-axis direction. Further, as shown in FIG. 4, the second manifold portion 18 is provided on a surface of the communication plate 15 on the +Z direction side without penetrating the communication plate 15 in the Z-axis direction.

The supply communication path 19 is a flow path communicating with one end portion of the pressure chamber 12 in the X-axis direction. A plurality of supply communication paths 19 are arranged along the Y-axis direction, that is, the arrangement direction, and are individually provided in each of the pressure chambers 12. The supply communication path 19 communicates the second manifold portion 18 with each pressure chamber 12, and supplies the ink in the manifold 100 to each pressure chamber 12.

The nozzle plate 20 is provided on a side opposite to the pressure chamber substrate 10, that is, on a surface of the communication plate 15 on the +Z direction side while interposing the communication plate 15 therebetween. The material of the nozzle plate 20 is not particularly limited, and, for example, a silicon substrate, a glass substrate, an SOI substrate, various ceramic substrates, and a metal substrate can be used. Examples of the metal substrate include a stainless steel substrate or the like. As the material of the nozzle plate 20, an organic substance, such as a polyimide resin, can also be used. However, it is preferable that the nozzle plate 20 uses a material substantially the same as the thermal expansion coefficient of the communication plate 15. As a result, when the temperatures of the nozzle plate 20 and the communication plate 15 change, it is possible to suppress the warp of the nozzle plate 20 and the communication plate 15 due to the difference in the thermal expansion coefficient.

A plurality of nozzles 21 are formed on the nozzle plate 20. Each nozzle 21 communicates with each pressure chamber 12 via the nozzle communication path 16. As shown in FIG. 2, the plurality of nozzles 21 are arranged along the arrangement direction of the pressure chamber 12, that is, the Y-axis direction. The nozzle plate 20 is provided with two nozzle rows in which the plurality of nozzles 21 are arranged in a row. The two nozzle rows correspond to the first pressure chamber row L1 and the second pressure chamber row L2, respectively.

As shown in FIG. 4, the compliance substrate 45 is provided together with the nozzle plate 20 on the side opposite to the pressure chamber substrate 10 while interposing the communication plate 15 therebetween, that is, on a surface of the communication plate 15 on the +Z direction side. The compliance substrate 45 is provided around the nozzle plate 20 and covers openings of the first manifold portion 17 and the second manifold portion 18 provided in the communication plate 15. In the present embodiment, the compliance substrate 45 includes a sealing film 46 made of a flexible thin film and a fixed substrate 47 made of a hard material such as metal. As shown in FIG. 4, a region of the fixed substrate 47, which faces the manifold 100, is an opening portion 48 completely removed in a thickness direction. Therefore, one surface of the manifold 100 is a compliance portion 49 sealed only by the sealing film 46.

As shown in FIG. 4, the diaphragm 50 and the piezoelectric element 300 are laminated on a side opposite to the nozzle plate 20 or the like, that is, on a surface of the pressure chamber substrate 10 on the −Z direction side while interposing the pressure chamber substrate 10 therebetween. The piezoelectric element 300 bends and deforms the diaphragm 50 to cause a pressure change in the ink in the pressure chamber 12. In FIG. 4, a configuration of the piezoelectric element 300 is simplified and shown for easy understanding of the technique. The diaphragm 50 is provided on the +Z direction side of the piezoelectric element 300, and the pressure chamber substrate 10 is provided on the +Z direction side of the diaphragm 50.

As shown in FIG. 4, the protective substrate 30 having substantially the same size as the pressure chamber substrate 10 is further bonded to the surface of the pressure chamber substrate 10 on the −Z direction side by an adhesive or the like. The protective substrate 30 has a holding portion 31 which is a space for protecting the piezoelectric element 300. The holding portion 31 is provided for each row of the piezoelectric elements 300 arranged along the arrangement direction, and, in the present embodiment, the holding portions 31 are formed side by side in two rows in the X-axis direction. Further, in the protective substrate 30, a through hole 32 extending along the Y-axis direction and penetrating along the Z-axis direction is provided between the two rows of holding portions 31.

As shown in FIG. 4, the case member 40 is fixed on the protective substrate 30. The case member 40 forms the manifold 100 that communicates with the plurality of pressure chambers 12, together with the communication plate 15. The case member 40 has substantially the same outer shape as the communication plate 15 in a plan view, and is bonded over the protective substrate 30 and the communication plate 15.

The case member 40 has an accommodation section 41, a supply port 44, a third manifold portion 42, and a coupling port 43. The accommodation section 41 is a space having a depth capable of accommodating the pressure chamber substrate 10 and the protective substrate 30. The third manifold portion 42 is a space formed on both outer sides of the accommodation section 41 in the X-axis direction in the case member 40. The manifold 100 is formed by coupling the third manifold portion 42 to the first manifold portion 17 and the second manifold portion 18 provided in the communication plate 15. The manifold 100 has a long shape that is continuous over the Y-axis direction. The supply port 44 communicates with the manifold 100 to supply ink to each manifold 100. The coupling port 43 is a through hole that communicates with the through hole 32 of the protective substrate 30, the relay substrate 120 is inserted thereto.

In the liquid discharge head 510 of the present embodiment, the ink supplied from the ink tank 550 shown in FIG. 1 is taken from the supply port 44 shown in FIG. 4, and an internal flow path from the manifold 100 to the nozzle 21 is filled with ink. After that, a voltage based on the drive signal is applied to each of the piezoelectric elements 300 corresponding to the plurality of pressure chambers 12. As a result, the diaphragm 50 bends and deforms together with the piezoelectric element 300, the pressure in each pressure chamber 12 increases, and ink droplets are discharged from each nozzle 21.

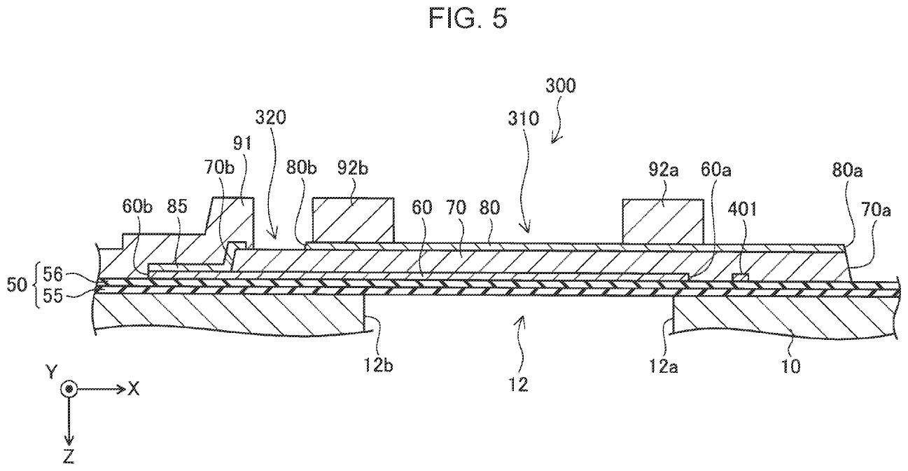

A configuration of the pressure chamber substrate 10 on the −Z direction side will be described with reference to FIGS. 3 to 6. FIG. 5 is an enlarged cross-sectional view showing the vicinity of the piezoelectric element 300. FIG. 6 is a cross-sectional view showing a VI-VI position of FIG. 3. The liquid discharge head 510 further includes an individual lead electrode 91, a common lead electrode 92, a measurement lead electrode 93, and a detection resistor 401 on the −Z direction side of the pressure chamber substrate 10, in addition to the diaphragm 50 and the piezoelectric element 300.

As shown in FIGS. 5 and 6, the diaphragm 50 includes an elastic film 55 made of silicon oxide provided on the pressure chamber substrate 10 side, and an insulator film 56 made of a zirconium oxide film provided on the elastic film 55. The flow path, such as the pressure chamber 12, which is formed in the pressure chamber substrate 10 is formed by anisotropic etching the pressure chamber substrate 10 from a surface on the +Z direction side, and a surface of the flow path, such as the pressure chamber 12, on the −Z direction side is made of the elastic film 55. The diaphragm 50 may be composed of, for example, either the elastic film 55 or the insulator film 56, and may further include another film other than the elastic film 55 and the insulator film 56. Examples of the material of the other film include silicon, silicon nitride, and the like.

The piezoelectric element 300 applies pressure to the pressure chamber 12. As shown in FIGS. 5 and 6, the piezoelectric element 300 has a first electrode 60, a piezoelectric body 70, and a second electrode 80. As shown in FIGS. 5 and 6, the first electrode 60, the piezoelectric body 70, and the second electrode 80 are laminated in order from the +Z direction side to the −Z direction side. The piezoelectric body 70 is provided between the first electrode 60 and the second electrode 80 in a lamination direction in which the first electrode 60, the second electrode 80, and the piezoelectric body 70 are laminated, that is, in the Z-axis direction.

Both the first electrode 60 and the second electrode 80 are electrically coupled to the relay substrate 120 shown in FIG. 4. The first electrode 60 and the second electrode 80 apply a voltage corresponding to the drive signal to the piezoelectric body 70. A different drive voltage is supplied to the first electrode 60 according to the amount of ink to be discharged, and a constant reference voltage signal is supplied to the second electrode 80 regardless of the amount of ink to be discharged. The amount of ink to be discharged is a volume change amount required for the pressure chamber 12. When the piezoelectric element 300 is driven and a potential difference is generated between the first electrode 60 and the second electrode 80, the piezoelectric body 70 is deformed. Due to the deformation of the piezoelectric body 70, the diaphragm 50 is deformed or vibrated, so that the volume of the pressure chamber 12 changes. Due to the change in the volume of the pressure chamber 12, pressure is applied to the ink accommodated in the pressure chamber 12, and the ink is discharged from the nozzle 21 via the nozzle communication path 16.

As shown in FIG. 5, a part of the piezoelectric element 300, at which piezoelectric distortion occurs in the piezoelectric body 70 when the voltage is applied between the first electrode 60 and the second electrode 80, is referred to as an active portion 310. On the other hand, a part at which the piezoelectric distortion does not occur in the piezoelectric body 70 is referred to as an inactive portion 320. That is, in the piezoelectric element 300, a part, at which the piezoelectric body 70 is sandwiched between the first electrode 60 and the second electrode 80, is the active portion 310, and a part, at which the piezoelectric body 70 is not sandwiched between the first electrode 60 and the second electrode 80, is the inactive portion 320. When the piezoelectric element 300 is driven, a part that is actually displaced in the Z-axis direction is also referred to as a flexible portion, and a part that is not displaced in the Z direction is also referred to as a non-flexible portion. That is, in the piezoelectric element 300, a part facing the pressure chamber 12 in the Z-axis direction is the flexible portion, and an outer part of the pressure chamber 12 is a non-flexible portion. The active portion 310 is also referred to as a proactive portion, and the inactive portion 320 is also referred to as a passive portion.

For example, the first electrode 60 is formed of a conductive material including a metal, such as platinum (Pt), iridium (Ir), gold (Au), titanium (Ti), and a conductive metal oxide such as indium tin oxide abbreviated as ITO. The first electrode 60 may be formed by laminating a plurality of materials such as platinum (Pt), iridium (Ir), gold (Au), and titanium (Ti). In the present embodiment, platinum (Pt) is used as the first electrode 60.

As shown in FIG. 3, the first electrode 60 is an individual electrode individually provided for the plurality of pressure chambers 12. A width of the first electrode 60 in the Y-axis direction is narrower than a width of the pressure chamber 12. That is, both ends of the first electrode 60 in the Y direction are positioned inside both ends of the pressure chamber 12 in the Y axis direction. As shown in FIG. 5, in the first electrode 60, an end portion 60a in the +X direction and an end portion 60b in the −X direction are respectively disposed outside the pressure chamber 12. For example, in the first pressure chamber row, the end portion 60a of the first electrode 60 is disposed at a position on the +X direction side with respect to the end portion 12a of the pressure chamber 12 in the +X direction. The end portion 60b of the first electrode 60 is disposed at a position which is the −X direction side rather than the end portion 12b of the pressure chamber 12 in the −X direction.

As shown in FIG. 3, the piezoelectric body 70 has a predetermined width in the X-axis direction, and is provided to extend along the arrangement direction of the pressure chambers 12, that is, the Y-axis direction. Examples of the piezoelectric body 70 include a crystal film having a perovskite structure formed on the first electrode 60 and made of a ferroelectric ceramic material exhibiting an electromechanical conversion action, that is, a so-called perovskite type crystal. As the material of the piezoelectric body 70, for example, a ferroelectric piezoelectric material such as lead zirconate titanate (PZT) or a material to which a metal oxide, such as niobium oxide, nickel oxide, or magnesium oxide, is added is used. Specifically, lead titanate (PbTiO3), lead zirconate titanate (Pb (Zr,Ti) O3), lead zirconium acid (PbZrO3), lead lanthanum titanate ((Pb,La),TiO3), lead lanthanum zirconate titanate ((Pb,La)(Zr, Ti)O3), lead magnesium niobate zirconate (Pb(Zr,Ti)(Mg,Nb)O3), or the like can be used. In the present embodiment, lead zirconate titanate (PZT) is used as the piezoelectric body 70.

The material of the piezoelectric body 70 is not limited to the lead-based piezoelectric material containing lead, and a non-lead-based piezoelectric material containing no lead can also be used. Examples of the non-lead-based piezoelectric material include bismuth iron acid ((BiFeO3), abbreviated as “BFO”), barium titanate ((BaTiO3), abbreviated as “BT”), potassium sodium niobate ((K, Na) (NbO3), abbreviated as “KNN”), potassium sodium lithium niobate ((K, Na, Li) (NbO3)), potassium sodium lithium titanate niobate ((K, Na, Li) (Nb, Ta) O3), bismuth potassium titanate ((Bi1/2K½) TiO3, abbreviated as “BKT”), bismuth sodium titanate ((Bi1/2Na½) TiO3, abbreviated as “BNT”), bismuth manganate (BimnO3, abbreviated as “BM”), composite oxide containing bismuth, potassium, titanium and iron and having a perovskite structure (x[(BixK1-x)TiO3]-(1-x)[BiFeO3], abbreviated as “BKT-BF”), composite oxide containing bismuth, iron, barium and titanium and having a perovskite structure ((1-x)[BiFeO3]-x[BaTiO3], abbreviated as “BFO-BT”), and a material ((1-x)[Bi(Fe1-yMy)O3]-x[BaTiO3] (M is Mn, Co or Cr)), which is obtained by adding metals, such as manganese, cobalt, and chromium, to the composite oxide.

The thickness of the piezoelectric body 70 is formed, for example, from approximately 1000 nanometers to 4000 nanometers. As shown in FIG. 5, the width of the piezoelectric body 70 in the X-axis direction is longer than the width in the X-axis direction which is the longitudinal direction of the pressure chamber 12. Therefore, on both sides of the pressure chamber 12 in the X-axis direction, the piezoelectric body 70 extends to the outside of the pressure chamber 12. As described above, the piezoelectric body 70 extends to the outside of the pressure chamber 12 in the X-axis direction, so that the strength of the diaphragm 50 is improved. Therefore, when the active portion 310 is driven to displace the piezoelectric element 300, it is possible to suppress the occurrence of cracks or the like in the diaphragm 50 or the piezoelectric element 300.

As shown in FIG. 5, the end portion 70a of the piezoelectric body 70 in the +X direction is positioned on the +X direction side, which is an outer side than the end portion 60a of the first electrode 60 in the first pressure chamber row. That is, the end portion 60a of the first electrode 60 is covered with the piezoelectric body 70. On the other hand, the end portion 70b of the piezoelectric body 70 in the −X direction is positioned on the +X direction side which is the inside rather than the end portion 60b of the first electrode 60, and the end portion 60b of the first electrode 60 is not covered with the piezoelectric body 70.

As shown in FIGS. 3 and 6, the piezoelectric body 70 is formed with a groove portion 71, which is a part thinner than the other regions. As shown in FIG. 6, the groove portion 71 is provided at a position corresponding to each partition wall 11. The groove portion 71 is formed by completely removing the piezoelectric body 70 in the Z-axis direction. The piezoelectric body 70 may be formed on a bottom surface of the groove portion 71 to be thinner than other parts. The width of the groove portion 71 in the Y-axis direction is formed to be the same as or wider than the width of the partition wall 11 in the Y-axis direction. As shown in FIG. 3, the groove portion 71 has a substantially rectangular appearance shape in a plan view. By providing the groove portion 71 in the piezoelectric body 70, the rigidity of a part of the diaphragm 50 facing the end portion of the pressure chamber 12 in the Y-axis direction, that is, a so-called arm portion of the diaphragm 50 is suppressed, so that the piezoelectric element 300 can be displaced better. The groove portion 71 is not limited to the rectangular shape, and may have a polygonal shape of pentagon or more, a circular shape, an elliptical shape, or the like.

As shown in FIGS. 5 and 6, the second electrode 80 is provided on an opposite side of the first electrode 60 while interposing the piezoelectric body 70, that is, on the −Z direction side of the piezoelectric body 70. As shown in FIG. 3, the second electrode 80 is a common electrode that is commonly provided for the plurality of pressure chambers 12 and is common to the plurality of active portions 310. The material of the second electrode 80 is not particularly limited, but, like the first electrode 60, for example, metals, such as platinum (Pt), iridium (Ir), gold (Au), and titanium (Ti), and conductive materials including conductive metal oxides, such as indium tin oxide abbreviated as ITO, are used. Alternatively, a plurality of materials such as platinum (Pt), iridium (Ir), gold (Au), and titanium (Ti) may be laminated and formed. In the present embodiment, iridium (Ir) is used as the second electrode 80.

As shown in FIG. 3, the second electrode 80 has a predetermined width in the X-axis direction, and is provided to extend along the arrangement direction of the pressure chambers 12, that is, the Y-axis direction. As shown in FIG. 6, the second electrode 80 is also provided on the insulator film 56 which is a side surface of the groove portion 71 of the piezoelectric body 70 and is a bottom surface of the groove portion 71.

As shown in FIG. 5, the end portion 80a of the second electrode 80 in the +X direction is disposed on an outer side than the end portion 60a of the first electrode 60 covered with the piezoelectric body 70, that is, on the +X direction side. The end portion 80a of the second electrode 80 is positioned on an outer side than the end portion 12a of the pressure chamber 12 and an outer side than the end portion 60a of the first electrode 60. In the present embodiment, the end portion 80a of the second electrode 80 substantially coincides with the end portion 70a of the piezoelectric body 70 in the X-axis direction. As a result, at end portion of the active portion 310 in the +X direction, the boundary between the active portion 310 and the inactive portion 320 is defined by the end portion 60a of the first electrode 60.

As shown in FIG. 5, the end portion 80b of the second electrode 80 in the −X direction is disposed on the −X direction side, which is an outer side than the end portion 12b of the pressure chamber 12 in the −X direction, and is disposed on the +X direction side, which is an inner side than the end portion 70b of the piezoelectric body 70. The end portion 70b of the piezoelectric body 70 is positioned inside which is the +X direction side with respect to the end portion 60b of the first electrode 60. Therefore, the end portion 80b of the second electrode 80 is positioned on the piezoelectric body 70 which is on the +X direction side with respect to the end portion 60b of the first electrode 60. On the −X direction side of the end portion 80b of the second electrode 80, there is a part at which a surface of the piezoelectric body 70 is exposed. As described above, the end portion 80b of the second electrode 80 is disposed on the +X direction side with respect to the end portion 70b of the piezoelectric body 70 and the end portion 60b of the first electrode 60. Therefore, at the end portion of the active portion 310 in the −X direction, the boundary between the active portion 310 and the inactive portion 320 is defined by the end portion 80b of the second electrode 80.

On the outside of the end portion 80b of the second electrode 80, a wiring portion 85 which is in the same layer as the second electrode 80 but is electrically discontinuous with the second electrode 80 is provided. The wiring portion 85 is formed from the vicinity of the end portion 70b of the piezoelectric body 70 to the end portion 60b of the first electrode 60 in a state of being spaced from the end portion 80b of the second electrode 80. The wiring portion 85 is provided for each active portion 310. That is, a plurality of wiring portions 85 are disposed at predetermined intervals along the Y-axis direction. The wiring portion 85 is preferably formed in the same layer as the second electrode 80. As a result, the cost can be reduced by simplifying a manufacturing process of the wiring portion 85. However, the wiring portion 85 may be formed in a layer different from the layer of the second electrode 80.

As shown in FIG. 5, the individual lead electrode 91 is coupled to the first electrode 60 which is an individual electrode, and the common lead electrode 92, which is a common electrode for drive, is electrically coupled to the second electrode 80, which is a common electrode, respectively. The individual lead electrode 91 and the common lead electrode 92 function as drive wirings for applying a voltage for driving the piezoelectric body 70 to the piezoelectric body 70. In the present embodiment, a power supply circuit for supplying electric power to the piezoelectric body 70 via the drive wiring and a power supply circuit for supplying electric power to the detection resistor 401 are different circuits from each other.

As shown in FIGS. 3 and 4, the individual lead electrode 91 and the common lead electrode 92 are extended to be exposed in the through hole 32 formed in the protective substrate 30, and are electrically coupled to the relay substrate 120 in the through hole 32. The relay substrate 120 is formed with a plurality of wirings for coupling a control substrate 580 and a power supply circuit (not shown). In the present embodiment, the relay substrate 120 is composed of, for example, a Flexible Printed Circuit (FPC). In addition, the relay substrate 120 may be composed of any flexible substrate, such as Flexible Flat Cable (FFC), instead of FPC.

An integrated circuit 121 having a switching element is mounted on the relay substrate 120. A signal for driving the piezoelectric element 300 propagating on the relay substrate 120 is input to the integrated circuit 121. The integrated circuit 121 controls a timing at which the signal for driving the piezoelectric element 300 is supplied to the first electrode 60 based on the input signal. As a result, the timing at which the piezoelectric element 300 is driven and the drive amount of the piezoelectric element 300 are controlled.

The materials of the individual lead electrode 91 and the common lead electrode 92 are conductive materials. For example, gold (Au), copper (Cu), titanium (Ti), tungsten (W), nickel (Ni), chromium (Cr), platinum (Pt), aluminum (Al), and the like can be used. In the present embodiment, gold (Au) is used as the individual lead electrode 91 and the common lead electrode 92. Further, the individual lead electrode 91 and the common lead electrode 92 may have an adhesion layer for improving the adhesion with the first electrode 60, the second electrode 80, and the diaphragm 50.

The individual lead electrode 91 and the common lead electrode 92 are formed in the same layer, but are formed so as to be electrically discontinuous. As a result, the cost can be reduced by simplifying the manufacturing process as compared with a case where the individual lead electrode 91 and the common lead electrode 92 are individually formed. The individual lead electrode 91 and the common lead electrode 92 may be formed in different layers.

The individual lead electrode 91 is provided for each active portion 310, that is, for each first electrode 60. As shown in FIG. 5, for example, the individual lead electrode 91 is coupled to the vicinity of the end portion 60b of the first electrode 60 via the wiring portion 85 in the first pressure chamber row L1, and is pulled out in the −X direction up to a top of the diaphragm 50.

As shown in FIG. 3, for example, in the first pressure chamber row L1, the common lead electrode 92 is bent at both end portions in the Y-axis direction and is pulled out from the second electrode 80 onto the diaphragm 50 in the −X direction. The common lead electrode 92 has an extension portion 92a and an extension portion 92b. As shown in FIG. 5, for example, in the first pressure chamber row L1, the extension portion 92a is extended along the Y-axis direction in a region corresponding to the end portion 12a of the pressure chamber 12, and the extension portion 92b is extended along the Y-axis direction to a region corresponding to the end portion 12b of the pressure chamber 12. The extension portion 92a and the extension portion 92b are continuously provided with respect to the plurality of active portions 310 in the Y-axis direction.

The extension portion 92a and the extension portion 92b extend from an inside of the pressure chamber 12 to an outside of the pressure chamber 12 in the X-axis direction. In the present embodiment, the active portion 310 of the piezoelectric element 300 extends to the outside of the pressure chamber 12 at both end portions of the pressure chamber 12 in the X-axis direction, and the extension portion 92a and the extension portion 92b extend to the outside of the pressure chamber 12 on the active portion 310.

As shown in FIGS. 3 and 5, in the present embodiment, the detection resistor 401 is further provided on a surface of the diaphragm 50 on the −Z direction side. Specifically, the detection resistor 401 is positioned between the diaphragm 50 and the piezoelectric body 70 in the Z-axis direction, and is covered with the piezoelectric body 70. That is, the detection resistor 401 is disposed at the same position as the piezoelectric element 300, that is, in the same layer as the piezoelectric element 300 in the lamination direction of the piezoelectric element 300 with respect to the pressure chamber substrate 10. The detection resistor 401 is a resistance wiring provided to correspond to a plurality of piezoelectric elements 300 provided in the first liquid discharge head 511. The detection resistor 401 is used to detect the temperature of the pressure chambers 12 corresponding to the plurality of piezoelectric elements 300. In the present embodiment, the temperature of the detection resistor 401 is detected by using the characteristic that an electric resistance value of a metal, a semiconductor, or the like changes depending on the temperature. When driving the piezoelectric element 300, the control section 540 measures an electric resistance value of the detection resistor 401 based on a current value of a current applied to the detection resistor 401 and a voltage value of a voltage generated in the detection resistor 401 due to the applied current, and further detects (estimates) the temperature of the pressure chamber 12 based on the correspondence relationship between the electric resistance value and the temperature of the detection resistor 401. For the detection resistor 401, a thermocouple may be used while being not limited to the resistance wiring.

The material of the detection resistor 401 is a material whose electric resistance value is temperature dependent. For example, gold (Au), platinum (Pt), iridium (Ir), aluminum (Al), copper (Cu), titanium (Ti), tungsten (W), nickel (Ni), chromium (Cr), and the like can be used. Here, platinum (Pt) can be preferably used as a material for the detection resistor 401 from a viewpoint that the change in electric resistance with temperature is large and stability and accuracy are high. The electric resistance value is an example of a measured value of the detection resistor to be measured. In the present embodiment, the detection resistor 401 is in the same layer as the first electrode 60 in the lamination direction, and is formed to be electrically discontinuous with the first electrode 60. The detection resistor 401 is formed together with the first electrode 60 in a step of forming the first electrode 60. Therefore, the material of the detection resistor 401 is platinum (Pt), which is the same as the material of the first electrode 60. As a result, the cost can be reduced by simplifying the manufacturing process as compared with a case where the detection resistor 401 is formed separately from the first electrode 60. However, the detection resistor 401 may be formed in a layer different from the layer of the first electrode 60.

As shown in FIG. 3, in the present embodiment, the detection resistor 401 is continuously formed so as to surround the periphery of the first pressure chamber row L1 and the second pressure chamber row L2. FIG. 3 shows a measurement lead electrode 93 including a measurement lead electrode 93a and a measurement lead electrode 93b. The measurement lead electrode 93 functions as a coupling portion for coupling the detection resistor 401 and the relay substrate 120. One end of the detection resistor 401 is coupled to the measurement lead electrode 93a, and the other end of the detection resistor 401 is coupled to the measurement lead electrode 93b. As a result, the detection resistor 401 is electrically coupled to the relay substrate 120, and the control section 540 can detect the electric resistance value of the detection resistor 401. In the example of FIG. 3, the detection resistor 401 is formed in a linear shape, but is not limited thereto, and, for example, may be formed as a so-called meandering pattern in which the detection resistor 401 is reciprocated a plurality of times in the vicinity of the first pressure chamber row L1 and the second pressure chamber row L2. With such a configuration, temperature detection accuracy of the pressure chamber 12 can be improved.

In the present embodiment, the measurement lead electrode 93 is formed in the same layer as the individual lead electrode 91 and the common lead electrode 92, and is formed to be electrically discontinuous. The material of the measurement lead electrode 93 is a conductive material, and includes, for example, gold (Au), copper (Cu), titanium (Ti), tungsten (W), nickel (Ni), chromium (Cr), platinum (Pt), aluminum (Al), and the like. In the present embodiment, gold (Au) is used as the measurement lead electrode 93. The material of the measurement lead electrode 93 is the same as the materials of the individual lead electrode 91 and the common lead electrode 92. The measurement lead electrode 93 may have an adhesion layer that improves adhesion to the detection resistor 401 and the diaphragm 50.

As shown in FIG. 3, in the present embodiment, the detection resistor 401 is continuously formed on an outside of the liquid discharge head 510 so as to surround the periphery of the first pressure chamber row L1 and the second pressure chamber row L2. A part of the detection resistor 401 is formed in a linear shape along the arrangement direction of the pressure chambers 12 in the first pressure chamber row L1, and is disposed on the +X direction side rather than the pressure chambers 12 included in the first pressure chamber row L1, that is, on an outer side of the liquid discharge head 510 in the intersection direction. In the present embodiment, the other part of the detection resistor 401 is formed in a linear shape along the arrangement direction of the pressure chambers 12 in the second pressure chamber row L2, and is disposed on the −X direction side rather than the pressure chambers 12 included in the second pressure chamber row L2, that is, on an outer side of the liquid discharge head 510 in the intersection direction.

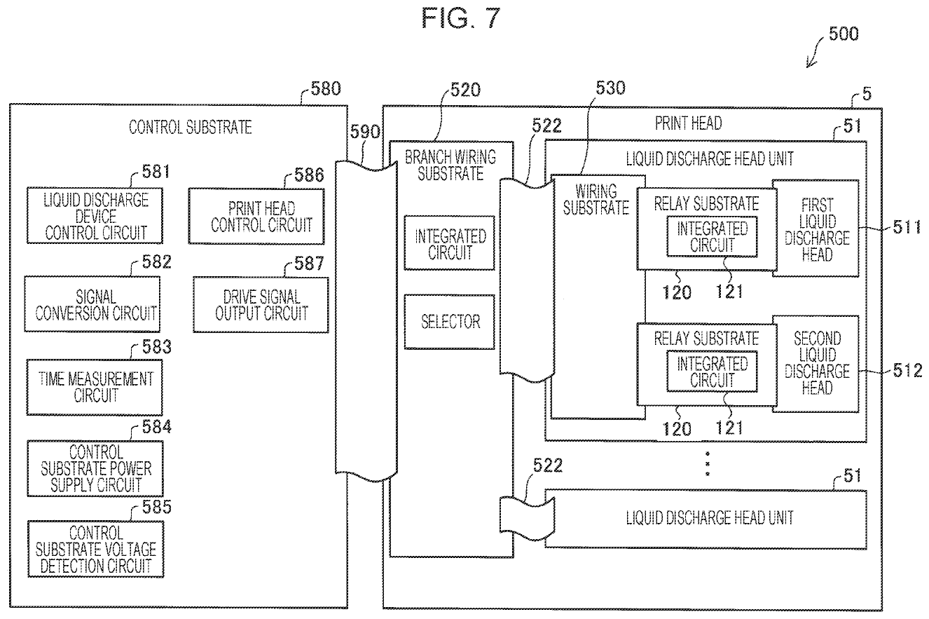

With reference to FIGS. 7 to 9, a functional configuration and a disposition method of the circuit substrate provided in the liquid discharge device 500 of the present embodiment will be described. FIG. 7 is a block diagram showing the functional configuration of the liquid discharge device 500. As shown in FIG. 7, the liquid discharge device 500 includes the print head 5 and the control substrate 580. The control substrate 580 is a substrate including a hardware logic circuit for realizing a function of the control section 540 described above. The control substrate 580 is formed by using a rigid substrate, and is disposed at a position different from a position of the print head 5 in a main body of the liquid discharge device 500. In the present embodiment, the control substrate 580 is separated from a wiring substrate 530, thereby reducing or suppressing heat transfer from each electronic circuit of the control substrate 580 to the temperature detection circuit 400. As shown in FIG. 7, the print head 5 has a plurality of liquid discharge head units 51, and each of the liquid discharge head units 51 has a first liquid discharge head 511 and a second liquid discharge head 512. In addition, in FIG. 7 and later, the ink tank 550, the transport mechanism 560, and the moving mechanism 570 are not shown.

The control substrate 580 and the print head 5 are communicably coupled to each other via the cable 590. In the present embodiment, a terminal group provided on the control substrate 580 and a terminal group provided on the branch wiring substrate 520 included in the print head 5 are electrically coupled to each other via the cable 590. As the cable 590, various cables, such as a Flexible Flat Cable (FFC) and a coaxial cable, are used according to a form of a propagated signal. The cable 590 may be an optical communication cable that propagates an optical signal.

The control substrate 580 generates a signal for controlling each configuration of the liquid discharge device 500 based on image data input from a host computer or the like provided outside the liquid discharge device 500, and outputs the signal to the corresponding configuration. The control substrate 580 includes a liquid discharge device control circuit 581, a signal conversion circuit 582, a time measurement circuit 583, a control substrate power supply circuit 584, a control substrate voltage detection circuit 585, a print head control circuit 586, and a drive signal output circuit 587. The control substrate 580 is not limited to be composed of one substrate, and may be composed of a plurality of substrates. For example, at least some of the plurality of circuits mounted on the control substrate 580 including the liquid discharge device control circuit 581, the signal conversion circuit 582, the time measurement circuit 583, the control substrate power supply circuit 584, the control substrate voltage detection circuit 585, the print head control circuit 586, and the drive signal output circuit 587 may be mounted on different substrates and may be electrically coupled to each other via a connector, a cable, or the like (not shown).

The commercial power supply is input to the control substrate power supply circuit 584. The control substrate power supply circuit 584 converts the input commercial power supply into, for example, a DC voltage of 42V and outputs the DC voltage. The DC voltage output from the control substrate power supply circuit 584 is input to the control substrate voltage detection circuit 585, and is also used as the power supply voltage of each configuration of the liquid discharge device 500. Here, each configuration of the liquid discharge device 500 may use the output DC voltage as the power supply voltage and the drive voltage without change, or may use a voltage signal converted into various voltage values, such as 3.3 V, 5 V, and 7.5 V, by a voltage conversion circuit (not shown) as a power supply voltage and a drive voltage.

The control substrate voltage detection circuit 585 detects whether or not a power supply voltage, such as a commercial power supply, is supplied to the liquid discharge device 500 based on the voltage value of the DC voltage output from the control substrate power supply circuit 584. The control substrate voltage detection circuit 585 generates a voltage detection signal at a logic level according to the detection result, and outputs the voltage detection signal to the time measurement circuit 583.

The time measurement circuit 583 determines whether or not the power supply voltage is supplied to the liquid discharge device 500 based on the input voltage detection signal. When the time measurement circuit 583 determines that the power supply voltage is supplied to the liquid discharge device 500 based on the voltage detection signal, elapsed time information is generated and output to the liquid discharge device control circuit 581.

The liquid discharge device control circuit 581 generates various signals for controlling an operation of each of the portions of the liquid discharge device 500 and outputs the signals to each of the portions of the liquid discharge device 500. A print head operation information signal including a drive situation of the print head 5 is input from the print head control circuit 586 to the liquid discharge device control circuit 581.

The print head control circuit 586 generates a drive data signal for driving the plurality of piezoelectric elements 300 included in the print head 5, a print data signal SI for controlling a timing of supplying a drive signal COM to the piezoelectric element 300, a clock signal SCK, a latch signal LAT, a change signal CH, and a switching signal SW. The print data signal SI, the clock signal SCK, the latch signal LAT, the change signal CH, and the switching signal SW, which are generated by the print head control circuit 586, are input to the print head 5 via the cable 590. The print head control circuit 586 generates and outputs the print data signal SI and the switching signal SW, which correspond to each of the plurality of liquid discharge heads 510 included in the print head 5, that is, the first liquid discharge head 511 and the second liquid discharge head 512. The print head control circuit 586 generates the drive data signal that defines a waveform of the drive signal COM for driving the piezoelectric element 300, and outputs the drive data signal to the drive signal output circuit 587.

The drive signal output circuit 587 generates the drive signal COM by performing digital/analog signal conversion on the input drive data signal and then performing class D amplification on the analog signal obtained through the conversion based on the DC voltage. In other words, the drive data signal is a digital signal that defines the waveform of the drive signal COM, and the drive signal output circuit 587 generates the drive signal COM by performing the class D amplification on the waveform defined by the drive data signal based on the DC voltage. The drive signal COM is input to the print head 5 via the cable 590. The drive data signal may be any signal that can define the waveform of the drive signal COM, and may be, for example, an analog signal. The drive signal output circuit 587 may amplify the waveform defined by the drive data signal, and may include, for example, a class A amplification circuit, a class B amplification circuit, a class AB amplification circuit, or the like.

The print head control circuit 586 outputs a memory control signal for controlling the memory included in the branch wiring substrate 520 which will be described later. Examples of the control of the memory include a read process for reading information stored in the memory, a write process for writing information to the memory, and the like. When the memory control signal is output, the stored data signal corresponding to the information read from the memory is input to the print head control circuit 586.

As shown in FIG. 7, the print head 5 has a branch wiring substrate 520 and a plurality of liquid discharge head units 51. The branch wiring substrate 520 is electrically coupled to each of the plurality of liquid discharge head units 51 via the cable 522. In the present embodiment, all the plurality of liquid discharge head units 51 included in the print head 5 have the same configuration, but may have different configurations from each other.

The drive signal COM, the print data signal SI, the clock signal SCK, the latch signal LAT, the change signal CH, and the switching signal SW are input to the branch wiring substrate 520 from the control substrate 580 via the cable 590. Each of the drive signal COM, the print data signal SI, the clock signal SCK, the latch signal LAT, the change signal CH, and the switching signal SW propagates through the branch wiring substrate 520 and is then input to the corresponding liquid discharge head unit 51.

The branch wiring substrate 520 has an integrated circuit including a memory and a selector. The selector is provided to correspond to each liquid discharge head unit 51. For example, a print data signal SI, a memory control signal MC, a latch signal LAT, and a change signal CH input from the control substrate 580 are input to the selector. According to the logic levels of the input latch signal LAT and the change signal CH, the selector selects whether to output the print data signal SI, the latch signal LAT, and the change signal CH to the liquid discharge head unit 51 or to output the memory control signal MC, the latch signal LAT, and the change signal CH to the memory. The memory stores information indicating an operating state of the print head 5 and a threshold value for determining whether or not to update the information. The memory in the present embodiment is a non-volatile memory that can be erased by ultraviolet rays, and, specifically, One-Time-PROM, EPROM, or the like is used. The memory is controlled by the memory control signal MC, the clock signal SCK, the latch signal LAT, and the change signal CH input via the selector.

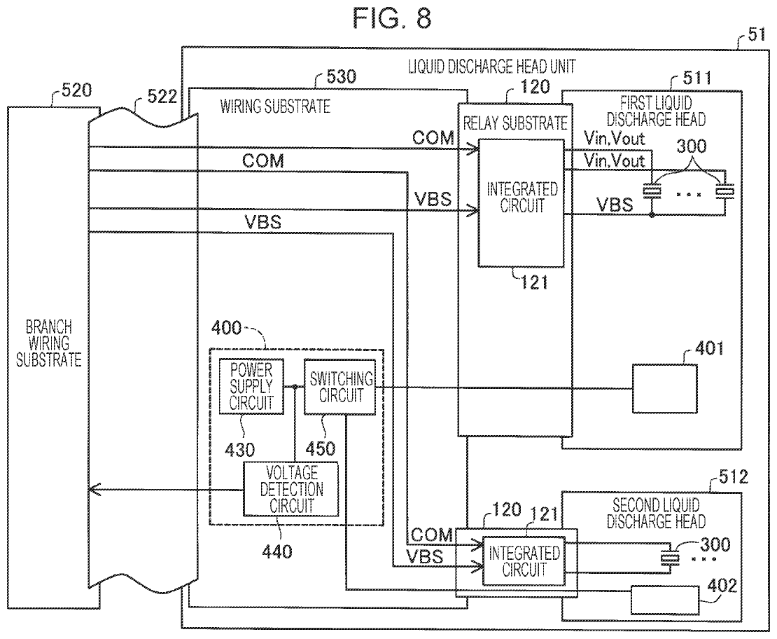

A functional configuration of the liquid discharge head unit 51 will be described with reference to FIG. 8. FIG. 8 is a block diagram showing the functional configuration of the liquid discharge head unit 51. As shown in FIG. 8, the liquid discharge head unit 51 has the wiring substrate 530, the first liquid discharge head 511, the second liquid discharge head 512, and the relay substrate 120.

The wiring substrate 530 is a Printed Circuit Board (PCB), and is, for example, a rigid substrate such as a ceramic substrate or a glass epoxy substrate. The wiring substrate 530 is electrically coupled to each of the first liquid discharge head 511 and the second liquid discharge head 512 via the relay substrate 120. Each of the drive signal COM, reference voltage signal VBS, the print data signal SI, the clock signal SCK, the latch signal LAT, the change signal CH, and the switching signal SW is input to the wiring substrate 530 from the branch wiring substrate 520 via the cable 522. Each of the drive signal COM, the reference voltage signal VBS, the print data signal SI, the clock signal SCK, the latch signal LAT, the change signal CH, and the switching signal SW, which are input to the wiring substrate 530, propagates through the wiring substrate 530 and is input to the relay substrate 120. That is, the wiring substrate 530 branches and relays the drive signal COM, the reference voltage signal VBS, the print data signal SI, the clock signal SCK, the latch signal LAT, the change signal CH, and the switching signal SW between the branch wiring substrate 520 and the first liquid discharge head 511 and the second liquid discharge head 512. The switching signal SW input to the relay substrate 120 switches whether the integrated circuit 121 outputs a drive voltage signal Vin or inputs a residual vibration Vout generated by the corresponding liquid discharge head 510 to the integrated circuit 121. The wiring substrate 530 is not limited to the rigid substrate, and various substrates, such as a flexible printed circuit and a rigid flexible printed circuit, may be used.

The relay substrate 120 individually couples each of the first liquid discharge head 511 and the second liquid discharge head 512 and the wiring substrate 530. The relay substrate 120 has the integrated circuit 121. The drive signal COM, the reference voltage signal VBS, the print data signal SI, the clock signal SCK, the latch signal LAT, the change signal CH, and the switching signal SW, which are input to the relay substrate 120, are input to the integrated circuit 121. In the present embodiment, the integrated circuit 121 has a switch, and switches whether to apply the drive signal COM to the piezoelectric element 300 or to make the piezoelectric element 300 non-conducting. In the following description, the drive signal COM after the integrated circuit 121 is also referred to as a drive voltage signal Vin. By controlling whether or not to select a signal waveform included in the drive signal COM at a timing defined by the print data signal SI, the clock signal SCK, the latch signal LAT, and the change signal CH, the integrated circuit 121 generates the drive voltage signal Vin and outputs the generated drive voltage signal Vin to the first electrode 60 of the piezoelectric element 300 included in the liquid discharge head 510.

The reference voltage signal VBS is supplied to the second electrode 80 of the piezoelectric element 300. The reference voltage signal VBS is a signal having a potential that is as a reference for the displacement of the piezoelectric element 300, and is, for example, a signal having a potential such as a ground potential, DC 5.5 V, or DC 6 V. In the present embodiment, the reference voltage signal VBS is generated by the drive signal output circuit 587. The reference voltage signal VBS may be generated by a voltage generation circuit (not shown) while being not limited to the drive signal output circuit 587. The piezoelectric elements 300 included in the first liquid discharge head 511 and the second liquid discharge head 512 are driven according to a potential difference between the drive voltage signal Vin supplied to the first electrode 60 and the reference voltage signal VBS supplied to the second electrode 80. As a result, the amount of ink corresponding to the drive of the piezoelectric elements 300 is discharged from the first liquid discharge head 511 and the second liquid discharge head 512.

The residual vibration Vout generated in the liquid discharge head 510 driven based on the drive voltage signal Vin is input to the integrated circuit 121 included in the relay substrate 120. The integrated circuit 121 may generate a residual vibration signal based on the input residual vibration Vout.

As shown in FIG. 8, in the present embodiment, the wiring substrate 530 is provided with a temperature detection circuit 400. The temperature detection circuit 400 is electrically coupled to each of the first detection resistor 401 provided in the first liquid discharge head 511 and the second detection resistor 402 of the second liquid discharge head 512, and detects a voltage value generated in the first detection resistor 401 and the second detection resistor 402. The plurality of piezoelectric elements 300 which is a detection target of the temperature by the first detection resistor 401 are also referred to as a “first piezoelectric element group”, and the plurality of piezoelectric elements 300 which are detection targets of the temperature by the second detection resistor 402 are also referred to as a “second piezoelectric element group”. The temperature detection circuit 400 includes a power supply circuit 430, a voltage detection circuit 440, and a switching circuit 450.

The power supply circuit 430 supplies electric power to the first detection resistor 401 and the second detection resistor 402. In the present embodiment, the power supply circuit 430 is a constant current circuit which causes a predetermined constant current to flow through the first detection resistor 401 and the second detection resistor 402. The power supply circuit 430 may be disposed at a position other than the wiring substrate 530, such as the branch wiring substrate 520 or the control substrate 580, in the liquid discharge device 500 while being not limited to the wiring substrate 530.

A current is supplied from the power supply circuit 430, and the voltage detection circuit 440 detects a voltage value between both terminals of the first detection resistor 401 and the second detection resistor 402 (a voltage value generated in the first detection resistor 401 and the second detection resistor 402). In the present embodiment, the voltage detection circuit 440 outputs the detected voltage value to the control substrate 580. The control substrate 580 acquires the temperature of the first pressure chamber by using the voltage generated in the first detection resistor 401 due to the current flowing from the power supply circuit 430, the voltage being detected by the voltage detection circuit 440, and acquires the temperature of the second pressure chamber by using the voltage generated in the second detection resistor 402 due to the current flowing from the power supply circuit 430, the voltage being detected by the voltage detection circuit 440. In the present embodiment, the storage circuit provided in the control substrate 580 stores in advance the correspondence relationship between the electric resistance value and the temperature of the detection resistor 401. The control substrate 580 calculates the electric resistance values of the first detection resistor 401 and the second detection resistor 402 by using the current value supplied from the power supply circuit 430 and the voltage value detected by the voltage detection circuit 440, and detects the temperature of each of the pressure chambers 12 of the first liquid discharge head 511 and the second liquid discharge head 512 based on the correspondence relationship between the electric resistance values and the temperatures of the first detection resistor 401 and the second detection resistor 402, which are stored in the storage circuit. The temperature detection circuit 400 is not limited to a form of outputting the voltage value to the control substrate 580, and the temperature detection circuit 400 may calculate the electric resistance value of the first detection resistor 401 and the second detection resistor 402, and may output the electric resistance value to the control substrate 580. The temperature detection circuit 400 may store in advance the correspondence relationship between the electric resistance values and the temperatures of the first detection resistor 401 and the second detection resistor 402 in the memory of the wiring substrate 530, and may output the temperature derived from the electric resistance value using the correspondence relationship to the control substrate 580.

The switching circuit 450 switches on and off of a switch element included in the temperature detection circuit 400 under the control of the control substrate 580. The switching circuit 450 switches to one of a first state, in which the voltage detection circuit 440 can detect a voltage value between both terminals of the first detection resistor 401 from the power supply circuit 430 by operating the switch element, and a second state in which the voltage detection circuit 440 can detect a voltage value between both terminals of the second detection resistor 402 from the power supply circuit 430.

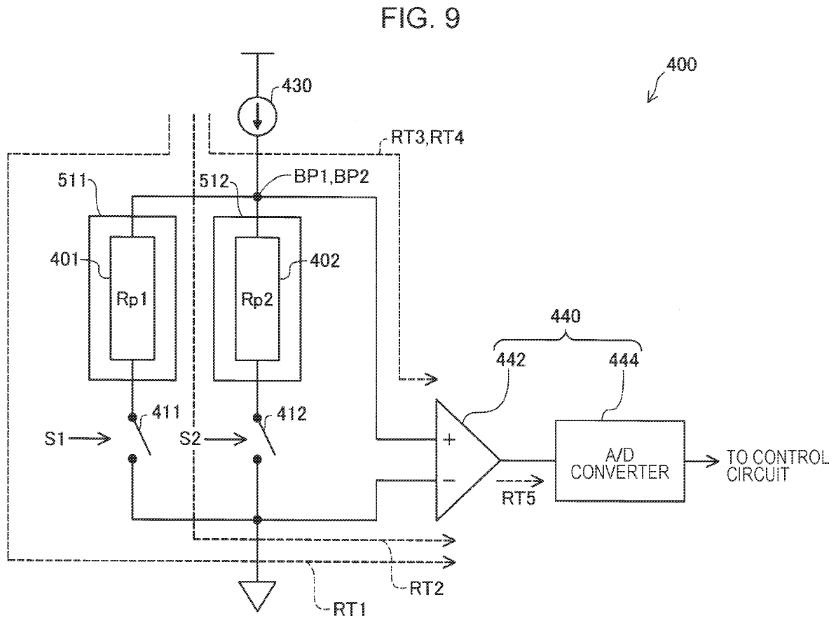

FIG. 9 is an explanatory diagram schematically showing a circuit configuration of the temperature detection circuit 400. In the present embodiment, the temperature detection circuit 400 is a parallel circuit including the first detection resistor 401 of the first liquid discharge head 511 and the second detection resistor 402 of the second liquid discharge head 512. An electric resistance value Rp1 of the first detection resistor 401 is substantially the same as an electric resistance value Rp2 of the second detection resistor 402. Approximately the same means that the electric resistance value Rp1 of the first detection resistor 401 is 0.5 to 1.5 times the electric resistance value Rp2 of the second detection resistor 402 under the same temperature environment.

As shown in FIG. 9, the temperature detection circuit 400 has routes including a first route RT1, a second route RT2, a third route RT3, and a fourth route RT4 from the power supply circuit 430 to the voltage detection circuit 440. The first route RT1 is a route that electrically couples the power supply circuit 430 and the voltage detection circuit 440 via the first detection resistor 401. The second route RT2 is a route different from the first route RT1 and is a route that electrically couples the power supply circuit 430 and the voltage detection circuit 440 via the second detection resistor 402. The first route RT1 and the second route RT2 are coupled to one input terminal of a first differential amplification circuit 442.

The third route RT3 is a route that electrically couples a first branch point BP1 and the voltage detection circuit 440 without passing through the first detection resistor 401. The third route RT3 has the same route as the first route RT1 from the power supply circuit 430 to the first branch point BP1, and has a different route from the first branch point BP1 to the voltage detection circuit 440. The first branch point BP1 branches the first route RT1 into the first route RT1 and the third route RT3. The first branch point BP1 is positioned between the first detection resistor 401 in the first route RT1 and the power supply circuit 430. The fourth route RT4 is a route that electrically couples the second branch point BP2 and the voltage detection circuit 440 without passing through the second detection resistor 402. The fourth route RT4 is the same route as the second route RT2 from the power supply circuit 430 to the second branch point BP2, and is a different route from the second branch point BP2 to the voltage detection circuit 440. The second branch point BP2 branches the second route RT2 into the second route RT2 and the fourth route RT4. The second branch point BP2 is positioned between the second detection resistor 402 in the second route RT2 and the power supply circuit 430. In the present embodiment, the first branch point BP1 and the second branch point BP2 are the same branch points, and the third route RT3 and the fourth route RT4 are the same routes. That is, the first route RT1 and the second route RT2 have a common route to the first branch point BP1 and the second branch point BP2, and the third route RT3 and the fourth route RT4 are coupled to the other input terminal of the first differential amplification circuit 442.

The temperature detection circuit 400 includes a first switch 411 and a second switch 412. The first switch 411 is provided between the first detection resistor 401 and the voltage detection circuit 440 in the middle of the first route RT1. Specifically, the first switch 411 is disposed on a downstream of the detection resistor 401, that is, at a position closer to the first differential amplification circuit 442 than the detection resistor 401 in the first route RT1. The second switch 412 is provided between the second detection resistor 402 and the voltage detection circuit 440 in the middle of the second route RT2. Specifically, the second switch 412 is disposed on a downstream of the detection resistor 402, that is, at a position closer to the first differential amplification circuit 442 than the detection resistor 402 in the second route RT2. The first switch 411 and the second switch 412 are individually switched on and off by select signals S1 and S2 output from the switching circuit 450. In the present embodiment, under the same temperature environment, on-resistance of the first switch 411 is set to be equal to or less than 1/100 of the electric resistance value Rp1 of the first detection resistor 401, and the on-resistance of the second switch 412 is set to be equal to or less than 1/100 of the electric resistance value Rp2 of the second detection resistor 402.

With an operation performed on the switch element by the switching circuit 450, the temperature detection circuit 400 switches the route from the power supply circuit 430 to the voltage detection circuit 440 into the first route RT1 including the first detection resistor 401 and the second route RT2 including the second detection resistor 402. Specifically, the temperature detection circuit 400 switches to the first state by turning on the first switch 411 to be a coupling state and turning off the second switch 412 to be a cutoff state by the switching circuit 450. The first state means a state in which the voltage detection circuit 440 can detect the voltage value between both terminals of the first detection resistor 401 from the power supply circuit 430. Further, the temperature detection circuit 400 switches to the second state by turning on the second switch 412 to be a coupling state, and turning off the first switch 411 to be a cutoff state. The second state means a state in which the voltage detection circuit 440 can detect the voltage value between both terminals of the second detection resistor 402 from the power supply circuit 430. In the present embodiment, the temperature detection circuit 400 switches between the first state and the second state by the switching circuit 450, and detects a voltage value generated in the detection resistor 401 and a voltage value generated in the detection resistor 402.

As shown in FIG. 9, the voltage detection circuit 440 includes a first differential amplification circuit 442 and an A/D converter 444. An output terminal of the first differential amplification circuit 442 and an input terminal of the voltage detection circuit 440 are electrically coupled by a fifth route RT5. The fifth route RT5 may be provided with a low-pass filter such as an RC filter. With such a configuration, it is possible to attenuate noise of a low frequency component caused by the drive signal of the piezoelectric element 300, and it is possible to reduce or suppress the decrease in measurement accuracy of the voltage value by the voltage detection circuit 440. The low-pass filter is preferably a second-order or higher-order low-pass filter including, for example, a plurality of RC filters. The low-pass filter is not limited to the RC filter, and may be an LC filter.

The first differential amplification circuit 442 is a so-called instrumentation amplifier, and amplifies a voltage applied from the power supply circuit 430 to the first detection resistor 401 and the second detection resistor 402 at a predetermined amplification rate. The amplified voltage value is output to the A/D converter 444 via the fifth route RT5. The A/D converter 444 converts an input analog voltage value into a digital signal, and outputs the digital signal to the control substrate 580. The first differential amplification circuit 442 may be omitted.

As described above, a liquid discharge head unit 51 of the present embodiment includes a liquid discharge head 510 provided with a plurality of pressure chambers 12, a plurality of piezoelectric elements 300, and a drive wiring for applying a voltage for driving the piezoelectric element 300 to the piezoelectric element 300, a first detection resistor 401 provided to correspond to a first piezoelectric element group among the plurality of piezoelectric elements 300 and formed of the same material as the piezoelectric element 300 or the drive wiring, and a second detection resistor 402 provided to correspond to a second piezoelectric element group different from the first piezoelectric element group among the plurality of piezoelectric elements 300 and formed of the same material as the piezoelectric element 300 or the drive wiring, a power supply circuit 430 for causing a current to flow through the first detection resistor 401 and the second detection resistor 402, a voltage detection circuit 440 for detecting the voltage, and a switching circuit 450. The switching circuit 450 switches between a first state in which the voltage detection circuit 440 can detect a voltage generated in the first detection resistor 401 by the current flowing from the power supply circuit 430, and a second state in which the voltage detection circuit 440 can detect a voltage generated in the second detection resistor 402 by the current flowing from the power supply circuit 430. According to the liquid discharge head unit 51 of the present embodiment, the voltage values of the plurality of detection resistors can be individually detected by switching between the first state and the second state, a wiring length of an entire temperature detection circuit 400 can be shortened by sharing the power supply circuit 430 and the voltage detection circuit 440 with respect to the plurality of detection resistors, so that the temperature detection circuit 400 can be miniaturized and the liquid discharge head unit 51 can be miniaturized. By shortening the wiring length of the temperature detection circuit 400, it is possible to reduce noise when the detection result is transmitted and improve the measurement accuracy by the temperature detection circuit 400.

According to the liquid discharge head unit 51 of the present embodiment, a plurality of liquid discharge heads 510 are further provided. The plurality of liquid discharge heads 510 include a first liquid discharge head 511 and a second liquid discharge head 512 different from the first liquid discharge head, and the first detection resistor 401 is provided in the first liquid discharge head 511, and the second detection resistor 402 is provided in the second liquid discharge head 512. Therefore, it is possible to individually detect the voltage of the detection resistor provided in each of the plurality of liquid discharge heads 510.

The liquid discharge head unit 51 of the present embodiment further includes a first route RT1 that electrically couples the power supply circuit 430 and the voltage detection circuit 440 via the first detection resistor 401, a second route RT2 that electrically couples the power supply circuit 430 and the voltage detection circuit 440 via the second detection resistor 402, a third route RT3 that electrically couples the power supply circuit 430 and the voltage detection circuit 440 without the first detection resistor 401, and a fourth route RT4 that electrically couples the power supply circuit 430 and the voltage detection circuit 440 without the second detection resistor 402. According to the liquid discharge head unit 51 of the present embodiment, the temperature detection circuit 400 can be made into a parallel circuit by a plurality of detection resistors while sharing the power supply circuit 430 and the voltage detection circuit 440. The wiring length of the entire temperature detection circuit 400 can be shortened with respect to the plurality of detection resistors, so that the temperature detection circuit 400 can be miniaturized and the liquid discharge head unit 51 can be miniaturized. By shortening the wiring length of the temperature detection circuit 400, it is possible to reduce noise when the detection result is transmitted and improve the measurement accuracy by the temperature detection circuit 400.

According to the liquid discharge head unit 51 of the present embodiment, there are provided a first switch 411 provided between the first detection resistor 401 and the voltage detection circuit 440 in the middle of the first route RT1 and a second switch 412 provided between the second detection resistor 402 and the voltage detection circuit 440 in the middle of the second route RT2. The switching circuit 450 switches to the first state by setting the first switch 411 to the coupling state and setting the second switch 412 to the cutoff state, and switches to the second state by setting the second switch 412 to the coupling state and setting the first switch 411 to the cutoff state. The voltage values of the plurality of detection resistors can be detected with a simple configuration by a so-called two-terminal measurement method. By sharing the power supply circuit 430 and the voltage detection circuit 440 for the plurality of detection resistors, the wiring length of the entire temperature detection circuit 400 can be shortened and the temperature detection circuit 400 can be miniaturized.

According to the liquid discharge head unit 51 of the present embodiment, on-resistance of the first switch 411 is set to be equal to or less than 1/100 of an electric resistance value of the first detection resistor 401, and on-resistance of the second switch 412 is set to be equal to or less than 1/100 of an electric resistance value of the second detection resistor 402. By reducing electric resistance values other than the first detection resistor 401 and the second detection resistor 402, such as the first switch 411 and the second switch 412, included in the temperature detection circuit 400, it is possible to reduce or suppress the decrease in the detection accuracy of the voltage value by the voltage detection circuit 440.

According to the liquid discharge head unit 51 of the present embodiment, a first branch point BP1 and a second branch point BP2 are the same branch point, and a third route RT3 and a fourth route RT4 are the same route. Therefore, the circuit configuration of the temperature detection circuit 400 can be further miniaturized, and the influence of noise on the detection result when transmitting the detection result of the voltage detection circuit 440 can be further reduced.

According to the liquid discharge head unit 51 of the present embodiment, the voltage detection circuit 440 includes a first differential amplification circuit 442 having one input terminal, to which the first route RT1 and the second route RT2 are coupled, and the other input terminal to which the third route RT3 and the fourth route RT4 are coupled, and a fifth route RT5 that couples the output terminal of the first differential amplification circuit 442 and an input terminal of the voltage detection circuit 440. It is possible to amplify the voltage values of the first detection resistor 401 and the second detection resistor 402, which are input to the first differential amplification circuit 442, and it is possible to improve the measurement accuracy.

According to the liquid discharge head unit 51 of the present embodiment, the power supply circuit 430 is a constant current circuit that causes a constant current to flow through the first detection resistor 401 and the second detection resistor 402. It is possible to reduce or suppress the influence of current fluctuations in the voltage values generated in the detection resistor 401 and the detection resistor 402, so that it is possible to improve the detection accuracy of the electric resistance values of the detection resistor 401 and the detection resistor 402.

According to the liquid discharge head unit 51 of the present embodiment, an electric resistance value of the first detection resistor 401 is 0.5 to 1.5 times an electric resistance value of the second detection resistor 402. Therefore, it is possible to reduce the measurement variation among the plurality of detection resistors by setting the electric resistance values of the plurality of detection resistors included in the temperature detection circuit 400 to substantially the same value.

According to the liquid discharge head unit 51 of the present embodiment, a temperature of the pressure chamber 12 is acquired by using the voltage generated in the first detection resistor 401 due to the current flowing from the power supply circuit 430, the voltage being detected by the voltage detection circuit 440, and a temperature of the pressure chamber 12 is acquired by using the voltage generated in the second detection resistor 402 due to the current flowing from the power supply circuit 430, the voltage being detected by the voltage detection circuit 440. Since the temperature is acquired using the voltage values generated in the detection resistors 401 and 402, the temperature detection circuit 400 can be miniaturized as compared with a case where a thermocouple or the like is used.

The liquid discharge head unit 51 of the present embodiment includes a wiring substrate 530 that is electrically coupled to the liquid discharge head 510. The switching circuit 450 is disposed at the wiring substrate 530. By disposing the switching circuit 450 at the wiring substrate 530 in the liquid discharge head unit 51, as compared with a case where the switching circuit 450 is disposed at a place, such as the control substrate 580, other than the liquid discharge head unit 51, it is possible to shorten the wiring length of the liquid discharge head 510 from the detection resistors 401 and 402 to the switching circuit 450 and it is possible to reduce noise when a detection result is transmitted, so that it is possible to improve the measurement accuracy of the electric resistance values of the detection resistors 401 and 402.

The liquid discharge device 500 of the present embodiment includes the liquid discharge head 510 of the aspect, and a control section 540 that controls the discharge operation of the liquid discharge head unit 51. According to the liquid discharge device 500 of the present embodiment, by providing the control section 540 outside the liquid discharge head unit 51, it is possible to reduce or suppress temperature detection circuit 400 from receiving the influence of heat transfer and electrical noise from the control substrate 580, so that it is possible to improve the temperature detection accuracy by the temperature detection circuit 400.

### B. Second Embodiment

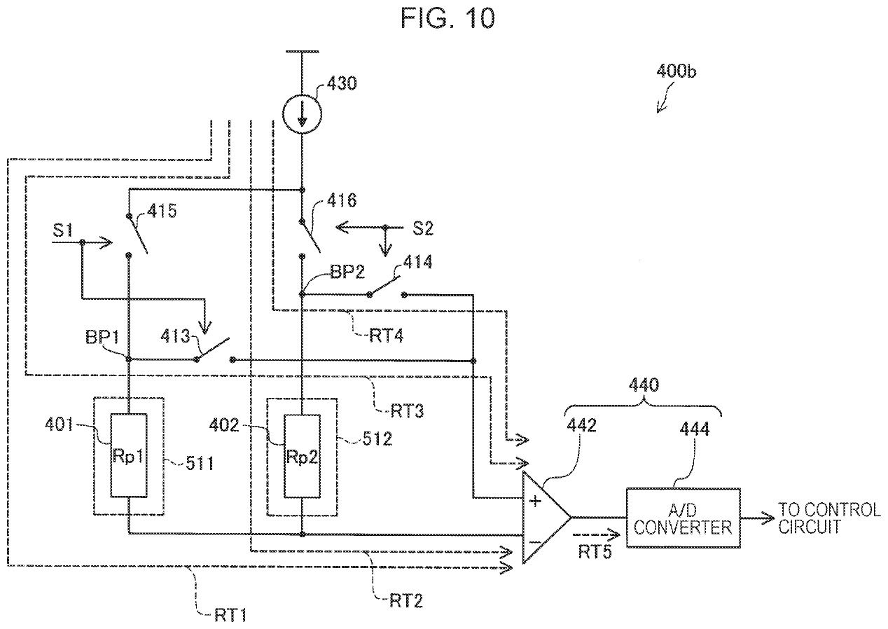

FIG. 10 is an explanatory diagram showing a temperature detection circuit 400b included in a liquid discharge head unit 51 of a second embodiment of the present disclosure. The liquid discharge head unit 51 of the second embodiment is different from the liquid discharge head unit 51 of the first embodiment in that a temperature detection circuit 400b using a so-called four-terminal measurement method is provided instead of the temperature detection circuit 400 using the two-terminal measurement method, and the other configurations are the same. In FIG. 10, a sixth route RT6, which will be described later, is not shown.

The temperature detection circuit 400b is a parallel circuit formed by a detection resistor 401 of a first liquid discharge head 511 and a detection resistor 402 of a second liquid discharge head 512, as in the first embodiment. The temperature detection circuit 400b has routes including a first route RT1, a second route RT2, a third route RT3, and a fourth route RT4 from a power supply circuit 430 to a voltage detection circuit 440. The third route RT3 and the fourth route RT4 are coupled to one input terminal of a first differential amplification circuit 442, and the first route RT1 and the second route RT2 are coupled to the other input terminal. In the present embodiment, the temperature detection circuit 400b is different from the temperature detection circuit 400 in the first embodiment in that a first branch point BP1 and a second branch point BP2 are different branch points from each other and the third route RT3 and the fourth route RT4 are different routes from each other.

The temperature detection circuit 400b includes a third switch 413, a fourth switch 414, a fifth switch 415, and a sixth switch 416, instead of the first switch 411 and the second switch 412 shown in the first embodiment. The third switch 413 is provided between the first branch point BP1 and the voltage detection circuit 440 in the middle of the third route RT3. For example, a switching circuit 450 can switch between a coupling state for causing a current to flow through the third route RT3 by turning on the third switch 413 and a cutoff state for cutting off the current flowing through the third route RT3 by turning off the third switch 413. The fourth switch 414 is provided between the second branch point BP2 and the voltage detection circuit 440 in the middle of the fourth route RT4. For example, the switching circuit 450 can switch between a coupling state for causing a current to flow through the fourth route RT4 by turning on the fourth switch 414 and a cutoff state for cutting off the current flowing through the fourth route RT4 by turning off the fourth switch 414. In the present embodiment, under the same temperature environment, on-resistance of the third switch 413 is set to be equal to or less than 1/100 of an electric resistance value Rp1 of the first detection resistor 401, and on-resistance of the fourth switch 414 is set to be equal to or less than 1/100 of an electric resistance value Rp2 of the second detection resistor 402.

The fifth switch 415 is provided between the power supply circuit 430 and the first branch point BP1 in the middle of the first route RT1. For example, the switching circuit 450 can switch between a coupling state for causing a current to flow through the first route RT1 by turning on the fifth switch 415 and a cutoff state for cutting off the current flowing through the first route RT1 by turning off the fifth switch 415. The sixth switch 416 is provided between the power supply circuit 430 and the second branch point BP2 in the middle of the second route RT2. For example, the switching circuit 450 can switch between a coupling state for causing a current to flow through the second route RT2 by turning on the sixth switch 416 and a cutoff state for cutting off the current flowing through the second route RT2 by turning off the sixth switch 416.

In the present embodiment, the switching circuit 450 switches to the first state in which the voltage detection circuit 440 can detect voltage values between both terminals of the first detection resistor 401 from the power supply circuit 430 by turning on a fifth switch 415 to be a coupling state and by turning off the sixth switch 416 to be a cutoff state. Further, the switching circuit 450 switches to the second state in which the voltage detection circuit 440 can detect voltage values between both terminals of the second detection resistor 402 from the power supply circuit 430 by turning on the sixth switch 416 to be a coupling state and by turning off the fifth switch 415 to be a cutoff state.

As shown in FIG. 10, in the present embodiment, the switching circuit 450 interlocks on and off switching between the third switch 413 and the fifth switch 415, and can switch between the coupling state and the cutoff state of the third switch 413 and can switch between the coupling state and the cutoff state of the fifth switch 415 by outputting a select signal S1. Similarly, the switching circuit 450 interlocks on and off switching between the fourth switch 414 and the sixth switch 416, and can switch between the coupling state and the cutoff state of the fourth switch 414 and the sixth switch 416 by outputting a select signal S2.

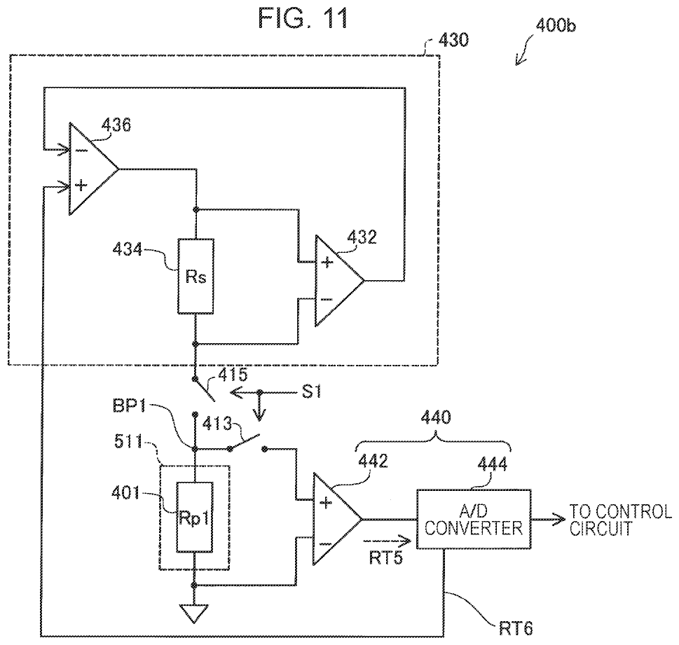

A detailed configuration of the power supply circuit 430 included in the temperature detection circuit 400b will be described with reference to FIG. 11. FIG. 11 is an explanatory diagram showing a circuit configuration of the power supply circuit 430 of the temperature detection circuit 400b. In FIG. 11, in order to facilitate understanding of the technique, circuit configurations corresponding to the second detection resistor 402 and the second detection resistor 402 are not shown.

As shown in FIG. 11, the power supply circuit 430 includes an operational amplifier 436, a power supply resistor 434, and a second differential amplification circuit 432. The power supply resistor 434 is electrically coupled to an output terminal of the operational amplifier 436. In the present embodiment, the second differential amplification circuit 432 is a so-called instrumentation amplifier having an amplification rate of G1. In the present embodiment, the same electric circuit is used for the first differential amplification circuit 442 and the second differential amplification circuit 432. The input terminals at both ends of the second differential amplification circuit 432 are electrically coupled to both ends of the power supply resistor 434, and an output terminal of the second differential amplification circuit 432 is coupled to one input terminal of the operational amplifier 436.

In the present embodiment, the temperature detection circuit 400b includes the sixth route RT6 that electrically couples the voltage detection circuit 440 and the power supply circuit 430. The sixth route RT6 is a route coupled to a non-inverting input of the operational amplifier 436. The sixth route RT6 inputs a reference voltage Vref output from the voltage detection circuit 440, more specifically, an A/D converter 444 to the non-inverting input of the operational amplifier 436. The sixth route RT6 may be omitted. In this case, an output voltage from a random circuit different from the A/D converter 444 may be input to the non-inverting input of the operational amplifier 436.

A potential difference Vd between the inputs of the second differential amplification circuit 432 is calculated by the following Equation (1), and a voltage value Vc output from the second differential amplification circuit 432 is calculated by the following Equation (2).

Vd=Ic·Rs Equation (1)

Vc=G1·Ic·Rs Equation (2)

Ic: Current value of constant current output from operational amplifier 436
Rs: Electric resistance value of power supply resistor 434
G1: Amplification rate of second differential amplification circuit 432

The voltage value Vc output from the second differential amplification circuit 432 is input to the inverting input of the operational amplifier 436, and the reference voltage Vref output from the A/D converter 444 is input to the non-inverting input of the operational amplifier 436. Therefore, since Vc=Vref, the following Equation (3) can be obtained by using Equation (2). A current value Ic of a current supplied from the power supply circuit 430 is derived by the following Equation (4) using Equation (3). As shown in Equation (4), the current value Ic of the current supplied from the power supply circuit 430 is proportional (specifically, first-order proportional) to the reference voltage Vref input via the sixth route RT6.

Vref=G1·Ic·Rs Equation (3)

Ic=Vref/(G1·Rs) Equation (4)

A potential difference Vp between the inputs of the first differential amplification circuit 442 is equal to the voltage value Vc applied to the first detection resistor 401. Therefore, the voltage value Vc can be derived using the following Equation (5).

Vp=Ic·Rp1 Equation (5)

Rp1: Electric resistance value of detection resistor 401

The voltage value Vq output from the first differential amplification circuit 442 is calculated by the following Equation (6). By using Equation (6) and Equation (4), the following Equation (7) can be obtained.

Vq=G2·Ic·Rp1 Equation (6)

Vq=(G2/G1)·(Rpt1/Rs)·Vref Equation (7)

G2: amplification rate of the first differential amplification circuit 442

By using the voltage value Vq obtained by Equation (7) and the current value Ic supplied from the power supply circuit 430, the electric resistance value Rp1 of the first detection resistor 401 is calculated. A control section 540 derives the temperature of the pressure chamber 12 by using the obtained electric resistance value Rp1 and the correspondence relationship between the electric resistance value Rp1 of the detection resistor 401 stored in the storage circuit in advance and the temperature.

According to the above Equation (7), the voltage value Vq output from the first differential amplification circuit 442 is proportional to G2/G1. In the present embodiment, the same electric circuit is used for the first differential amplification circuit 442 and the second differential amplification circuit 432. As a result, the amplification rate G2 of the first differential amplification circuit 442 and the amplification rate G1 of the second differential amplification circuit 432 are substantially equal to each other, so that it is possible to reduce influence based on the amplification rate of the first differential amplification circuit 442 and the second differential amplification circuit 432, thereby improving the detection accuracy of the voltage value by the temperature detection circuit 400b.

As described above, according to the liquid discharge head unit 51 of the aspect, the first route RT1 and the third route RT3 have the same route from the power supply circuit 430 to the first branch point BP1, and have different routes from the first branch point BP1 to the voltage detection circuit 440. The second route RT2 and the fourth route RT4 have the same route from the power supply circuit 430 to the second branch point BP2, and have different routes from the second branch point BP2 to the voltage detection circuit 440. Further, the third switch 413 provided between the first branch point BP1 and the voltage detection circuit 440 in the middle of the third route RT3, and the fourth switch 414 provided between the second branch point BP2 and the voltage detection circuit 440 in the middle of the fourth route RT4 are further provided. The switching circuit 450 switches to the first state by setting the third switch 413 to the coupling state and setting the fourth switch 414 to the cutoff state, and switches to the second state by setting the fourth switch 414 to the coupling state and setting the third switch 413 to the cutoff state. According to the liquid discharge head unit 51 of the present embodiment, it is possible to suppress the influence of the on-resistance of each of the switches 413, 414, 415, and 416 by the temperature detection circuit 400b using the so-called 4-terminal measurement method, and it is possible to improve the measurement accuracy of the voltage value by the voltage detection circuit 440.

According to the liquid discharge head unit 51 of the present embodiment, the fifth switch 415 provided between the power supply circuit 430 and the first branch point BP1 in the middle of the first route RT1 and the sixth switch 416 provided between the power supply circuit 430 and the second branch point BP2 in the middle of the second route RT2 are further included. The switching circuit 450 switches to the first state by setting the fifth switch 415 to the coupling state and setting the sixth switch 416 to the cutoff state, and switches to the second state by setting the sixth switch 416 to the coupling state and setting the fifth switch 415 to the cutoff state. According to the liquid discharge head unit 51 of the present embodiment, it is possible to suppress the influence of the on-resistance of each switch 413, and it is possible to improve the measurement accuracy of the voltage value by the voltage detection circuit 440.

According to the liquid discharge head unit 51 of the present embodiment, the switching circuit 450 interlocks the third switch 413 and the fifth switch 415 to switch between the coupling state and the cutoff state of the third switch 413 and the fifth switch 415, and interlocks the fourth switch 414 and the sixth switch 416 to switch between the coupling state and the cutoff state of the fourth switch 414 and the sixth switch 416. Therefore, it is possible to switch between the first state and the second state of the temperature detection circuit 400b by a simple method.

According to the liquid discharge head unit 51 of the present embodiment, on-resistance of the third switch 413 is set to be equal to or less than 1/100 of the electric resistance value Rp1 of the first detection resistor 401, and on-resistance of the fourth switch 414 is set to be equal to or less than 1/100 of the electric resistance value Rp2 of the second detection resistor 402. By reducing electric resistance values other than the first detection resistor 401 and the second detection resistor 402 in the temperature detection circuit 400b, it is possible to reduce or suppress the decrease in a detection accuracy of the voltage value Vq by the voltage detection circuit 440.

According to the liquid discharge head unit 51 of the present embodiment, the sixth route RT6 that electrically couples the voltage detection circuit 440 and the power supply circuit 430, that is, the sixth route RT6 for outputting the reference voltage Vref of the voltage detection circuit 440 is provided. The A/D converter 444 performs AD conversion based on the reference voltage Vref. The power supply circuit 430 takes out a current proportional to the reference voltage Vref input via the sixth route RT6. Therefore, as shown in Equation (7), the voltage value Vq output from the first differential amplification circuit 442 is defined by the reference voltage Vref, and an error, which is caused by the A/D converter 444, in the voltage value Vq can be reduced.

According to the liquid discharge head unit 51 of the present embodiment, the power supply circuit 430 includes an operational amplifier 436, the power supply resistor 434 coupled to the output terminal of the operational amplifier 436, and the second differential amplification circuit 432 whose input terminals at both ends are coupled to both ends of the power supply resistor 434 and whose output terminal is coupled to one input terminal of the operational amplifier 436. Therefore, by feeding back the voltage value obtained by multiplying the amplification rate G1 of the second differential amplification circuit 432 to the operational amplifier 436, it is possible to reduce the fluctuation in the current value Ic taken out from the power supply circuit 430.

### C. Other Aspects

(C1) The second embodiment shows an example in which the temperature detection circuit 400b includes the third switch 413, the fourth switch 414, the fifth switch 415, and the sixth switch 416. Further, in the temperature detection circuit 400b, an example is shown in which the first branch point BP1 is a branch point different from the second branch point BP2 and the third route RT3 is a route different from the fourth route RT4. On the other hand, the temperature detection circuit 400b may not include the fifth switch 415 and the sixth switch 416. In this case, for example, the third route RT3 and the fourth route RT4 may be routes different from each other and the first branch point BP1 and the second branch point BP2 may be branch points different from each other. According to the liquid discharge head unit 51 of the aspect, the switching circuit 450 can switch to the first state by setting the third switch 413 to the coupling state and setting the fourth switch 414 to the cutoff state, and can switch to the second state by setting the fourth switch 414 to the coupling state and setting the third switch 413 to the cutoff state.

(C2) In the second embodiment, an example is shown in which the first differential amplification circuit 442 and the second differential amplification circuit 432 are instrumentation amplifiers. On the other hand, for the first differential amplification circuit 442 and the second differential amplification circuit 432, a differential amplification circuit, such as an operational amplifier, other than the instrumentation amplifier may be used.

(C3) In each of the embodiments, an example is shown in which the liquid discharge head unit 51 is provided with two liquid discharge heads, that is, the first liquid discharge head 511 and the second liquid discharge head 512. On the other hand, the number of liquid discharge heads provided in the liquid discharge head unit 51 is not limited to two, and may be three including the first liquid discharge head 511, the second liquid discharge head 512, and the third liquid discharge head. There is a case where the pressure chamber 12 provided in the third liquid discharge head is referred to as a third pressure chamber, the piezoelectric element 300 is referred to as a third piezoelectric element, the drive wiring is referred to as a third drive wiring, and the detection resistor is referred to as a third detection resistor. In this case, by switching the on and off of the switch element included in the temperature detection circuit 400 under the control of the control substrate 580, the switching circuit 450 switches to any of the first state, the second state, and third state in which the voltage detection circuit 440 can detect the voltage value generated in the third detection resistor by applying a current from the power supply circuit 430. The configuration of the third liquid discharge head may be the same as or different from the configuration of the first liquid discharge head 511 and the second liquid discharge head 512. The number of liquid discharge heads provided in the liquid discharge head unit 51 is not limited to two or three, and may be one or may be equal to or larger than four.

(C4) In each of the above embodiments, an example is shown in which the first electrode 60 is an individual electrode and the second electrode 80 is a common electrode. However, the first electrode 60 may be a common electrode and the second electrode 80 may be an individual electrode. In this case, the first electrode 60 is provided on the +Z direction side with respect to the piezoelectric body 70, and is commonly provided for the plurality of pressure chambers 12. Further, the second electrode 80 is provided on the −Z direction side with respect to the piezoelectric body 70, and is individually provided for the plurality of pressure chambers 12. The first electrode 60 is coupled to the common lead electrode 92, and the second electrode 80 is coupled to the individual lead electrode 91.

In the liquid discharge head unit 51 of the aspect, in a fourth state, the integrated circuit 121 may further output the drive voltage signal Vin to the second piezoelectric element, in addition to the first piezoelectric element. According to the liquid discharge head unit 51 of the aspect, it is possible to avoid simultaneous execution of the drive of the piezoelectric element 300 in the second liquid discharge head 512 in addition to the first liquid discharge head 511 and the voltage detection by the temperature detection circuit 400, and it is possible to reduce or prevent the decrease in the detection accuracy of the voltage value applied to the second detection resistor 402 by the temperature detection circuit 400. In this case, the output of the drive voltage signal Vin to the first piezoelectric element and the second piezoelectric element may be switched by turning on and off a seventh switch of a seventh route. Further, when a route for electrically coupling the integrated circuit 121 and the second piezoelectric element is an eighth route, the drive voltage signal Vin output from the integrated circuit 121 may be output to the second piezoelectric element via the eighth route. In this case, for example, an eighth switch may be provided which can switch to a coupling state for causing a current to flow through the eighth route and a cutoff state for cutting off the current flowing through the eighth route by the switching circuit 450.

Further, in each of the embodiments, a timing at which the switching circuit 450 switches each switch is preferably set to a period during which the potential of the drive signal COM does not change. For example, when the maximum voltage of the drive signal COM is a first voltage, the minimum voltage of the drive signal COM is a second voltage, and a voltage between the first voltage and the second voltage is a third voltage, it is possible to use the drive signal COM so that, for one cycle, a first period which is constant at the third voltage, a second period in which the voltage drops from the third voltage to the second voltage, a third period which is constant at the second voltage, a fourth period in which the voltage rises from the second voltage to the first voltage, a fifth period which is constant at the first voltage, a sixth period in which the voltage drops from the first voltage to the third voltage, and a seventh period which is constant at the third voltage change in this order. In this case, the second period, the fourth period, and the sixth period, in which the voltage of the drive signal COM changes in one cycle, correspond to a period during which the current is supplied to the piezoelectric element 300, so that large noise is generated. Therefore, when the switching circuit 450 switches the switch during the periods, it is difficult to detect the temperature with high accuracy. Therefore, it is preferable that the switching circuit 450 switches each switch in the first period, the third period, the fifth period, and the seventh period in which the voltage of the drive signal COM does not change in one cycle. Further, since the detection temperature may change within one cycle, it is more preferable that the switching circuit 450 switches each switch in the first period or the seventh period in order to suppress the variation in the measurement result due to the change. In this case, for example, each switch is operated to be switched in synchronization with an LAT signal.

(C5) In each of the embodiments, an example is shown in which the liquid discharge head unit 51 includes a plurality of liquid discharge heads including the first liquid discharge head 511 and the second liquid discharge head 512, the first liquid discharge head 511 includes the first detection resistor 401, and the second liquid discharge head 512 includes the second detection resistor 402. On the other hand, the first liquid discharge head 511 may include a plurality of detection resistors. For example, the first liquid discharge head 511 may include two detection resistors, that is, the first detection resistor 401 that uses the first piezoelectric element group as a detection target among the plurality of piezoelectric elements 300 provided in the first liquid discharge head 511, and the second detection resistor 402 that uses the second piezoelectric element group as the detection target among the plurality of piezoelectric elements 300 provided in the first liquid discharge head 511. Further, the first liquid discharge head 511 may further include the third detection resistor that uses the third piezoelectric element group, which is different from the first piezoelectric element group and the second piezoelectric element group, as the detection target among the plurality of piezoelectric elements 300 provided in the first liquid discharge head 511. In this case, the switching circuit 450 may switch to the third state in which the voltage detection circuit 440 can detect the voltage generated in the third detection resistor by the current flowing from the power supply circuit 430. Further, the first liquid discharge head 511 may be provided with four or more detection resistors. According to the liquid discharge head unit of the aspect, it is possible to individually measure the temperature of each of the plurality of pressure chamber groups provided in one liquid discharge head 510. Similarly, the second liquid discharge head 512 may include a plurality of detection resistors. When the liquid discharge head unit 51 includes three or more liquid discharge heads, each of the three or more liquid discharge heads may include a plurality of detection resistors.

The present disclosure is not limited to the above-described embodiments, and can be realized in various configurations without departing from the gist of the present disclosure. Technical features in the embodiments corresponding to technical features in respective aspects described in outline of the present disclosure can be appropriately replaced or combined in order to solve some or all of the above-described problems or achieve some or all of the above-described effects. Further, when the technical features are not described as essential in the present specification, the technical features can be appropriately deleted.

(1) According to an aspect of the present disclosure, a liquid discharge head unit is provided. The liquid discharge head unit includes a liquid discharge head that has a plurality of pressure chambers, a plurality of piezoelectric elements, and a drive wiring for applying a voltage for driving the piezoelectric elements to the piezoelectric elements, a first detection resistor that is provided to correspond to a first piezoelectric element group among the plurality of piezoelectric elements, and formed of the same material as the piezoelectric elements or the drive wiring, a second detection resistor that is provided to correspond to a second piezoelectric element group different from the first piezoelectric element group among the plurality of piezoelectric elements, and formed of the same material as the piezoelectric elements or the drive wiring, a power supply circuit that causes a current to flow through the first detection resistor and the second detection resistor, a voltage detection circuit that detects a voltage, and a switching circuit that is configured to switch between a first state in which the voltage detection circuit is configured to detect a voltage generated in the first detection resistor due to the current flowing from the power supply circuit and a second state in which the voltage detection circuit is configured to detect a voltage generated in the second detection resistor due to the current flowing from the power supply circuit. According to the liquid discharge head unit of the aspect, a temperature detection section can be disposed in the liquid discharge head. Further, the voltage values of the plurality of detection resistors can be individually detected and temperatures can be individually detected by switching between the first state and the second state, a wiring length of an entire temperature detection circuit can be shortened by sharing the power supply circuit and the voltage detection circuit with respect to the plurality of detection resistors, so that the liquid discharge head unit can be miniaturized.

(2) In the liquid discharge head unit of the aspect, a plurality of the liquid discharge heads may be provided. The plurality of liquid discharge heads may include a first liquid discharge head and a second liquid discharge head different from the first liquid discharge head. The first detection resistor may be provided in the first liquid discharge head, and the second detection resistor may be provided in the second liquid discharge head. According to the liquid discharge head unit of the aspect, it is possible to individually detect the voltage of the detection resistor provided in each of the plurality of liquid discharge heads.

(3) In the liquid discharge head unit of the aspect, first detection resistor and the second detection resistor may be provided in the liquid discharge head. According to the liquid discharge head unit of the aspect, the voltage of the detection resistor provided for each of the plurality of pressure chamber groups provided in the liquid discharge head can be individually detected.

(4) The liquid discharge head unit of the aspect may further include a first route that electrically couples the power supply circuit and the voltage detection circuit via the first detection resistor, a second route that electrically couples the power supply circuit and the voltage detection circuit via the second detection resistor, a third route that electrically couples the power supply circuit and the voltage detection circuit without the first detection resistor, and a fourth route that electrically couples the power supply circuit and the voltage detection circuit without the second detection resistor. According to the liquid discharge head unit of the aspect, the temperature detection circuit can be made into a parallel circuit by a plurality of detection resistors while sharing the power supply circuit and the voltage detection circuit. The wiring length of the entire temperature detection circuit can be shortened, so that temperature detection circuit can be miniaturized and the liquid discharge head unit can be miniaturized.

(5) The liquid discharge head unit of the aspect may further include a first switch provided between the first detection resistor and the voltage detection circuit in the middle of the first route, and a second switch provided between the second detection resistor and the voltage detection circuit in the middle of the second route. The switching circuit may switch to the first state by setting the first switch to a coupling state and setting the second switch to a cutoff state, and may switch to the second state by setting the second switch to a coupling state and setting the first switch to a cutoff state. According to the liquid discharge head unit of the aspect, the voltage values of the plurality of detection resistors can be detected by a simple configuration.

(6) In the liquid discharge head unit of the aspect, on-resistance of the first switch may be equal to or less than 1/100 of an electric resistance value of the first detection resistor. On-resistance of the second switch may be equal to or less than 1/100 of an electric resistance value of the second detection resistor. According to the liquid discharge head unit of the aspect, it is possible to reduce or suppress decrease in detection accuracy of the voltage value by the voltage detection circuit by reducing electric resistance values other than the first detection resistor and the second detection resistor included in the temperature detection circuit.

(7) In the liquid discharge head unit of the aspect, the first branch point and the second branch point may be the same branch point. The third route and the fourth route may be the same route. According to the liquid discharge head unit of the aspect, the circuit configuration of the temperature detection circuit can be further miniaturized.

(8) In the liquid discharge head unit of the aspect, the first route and the third route may be the same route from the power supply circuit to a first branch point and may be different routes from the first branch point to the voltage detection circuit, and the second route and the fourth route may be the same route from the power supply circuit to a second branch point and may be different routes from the second branch point to the voltage detection circuit. The liquid discharge head unit may further include a third switch provided between the first branch point and the voltage detection circuit in the middle of the third route, and a fourth switch provided between the second branch point and the voltage detection circuit in the middle of the fourth route. The switching circuit may switch to the first state by setting the third switch to a coupling state and setting the fourth switch to a cutoff state, and switches to the second state by setting the fourth switch to a coupling state and setting the third switch to a cutoff state. According to the liquid discharge head unit of the aspect, the voltage values of the plurality of detection resistors can be individually detected, and a wiring length of an entire temperature detection circuit can be shortened by sharing the power supply circuit and the voltage detection circuit with respect to the plurality of detection resistors, so that the liquid discharge head unit can be miniaturized.

(9) The liquid discharge head unit of the aspect may further include a fifth switch provided between the power supply circuit and the first branch point in the middle of the first route, and a sixth switch provided between the power supply circuit and the second branch point in the middle of the second route. The switching circuit may switch to the first state by setting the fifth switch to a coupling state and setting the sixth switch to a cutoff state, and may switch to the second state by setting the sixth switch to a coupling state and setting the fifth switch to a cutoff state. According to the liquid discharge head unit of the aspect, it is possible to suppress influence of the on-resistance of each switch, and it is possible to improve the measurement accuracy of the voltage value by the voltage detection circuit.

(10) In the liquid discharge head unit of the aspect, the switching circuit may interlock the third switch and the fifth switch to switch between the coupling state and the cutoff state of the third switch and the fifth switch, and may interlock the fourth switch and the sixth switch to switch between the coupling state and the cutoff state of the fourth switch and the sixth switch. According to the liquid discharge head unit of the aspect, it is possible to switch between the first state and the second state of the temperature detection circuit by a simple method.

(11) In the liquid discharge head unit of the aspect, on-resistance of the third switch may be equal to or less than 1/100 of an electric resistance value of the first detection resistor. On-resistance of the fourth switch may be equal to or less than 1/100 of an electric resistance value of the second detection resistor. According to the liquid discharge head unit of the aspect, it is possible to reduce or suppress the decrease in detection accuracy of the voltage value by the voltage detection circuit by reducing electric resistance values other than the first detection resistor and the second detection resistor in the temperature detection circuit.

(12) In the liquid discharge head unit of the aspect, the voltage detection circuit may include a first differential amplification circuit having one input terminal, to which the first route and the second route are coupled, and the other input terminal to which the third route and the fourth route are coupled, and a fifth route that couples an output terminal of the first differential amplification circuit and an input terminal of the voltage detection circuit. According to the liquid discharge head unit of the aspect, it is possible to amplify the voltage values of the first detection resistor and the second detection resistor, which are input to the first differential amplification circuit, and it is possible to improve the measurement accuracy.

(13) In the liquid discharge head unit of the aspect, the power supply circuit may be a constant current circuit that causes a constant current to flow through the first detection resistor and the second detection resistor. According to the liquid discharge head unit of the aspect, it is possible to suppress influence of fluctuation in the current with respect to the voltage value applied to the first detection resistor and the second detection resistor.

(14) The liquid discharge head unit of the aspect may further include a sixth route that electrically couples the voltage detection circuit and the power supply circuit to output a reference voltage of the voltage detection circuit. The power supply circuit may take out a current proportional to the reference voltage input via the sixth route. According to the liquid discharge head unit of the aspect, the voltage value output from the first differential amplification circuit is defined by the reference voltage, and an error caused by the A/D converter can be reduced.

(15) In the liquid discharge head unit of the aspect, the power supply circuit may include an operational amplifier, a power supply resistor coupled to an output terminal of the operational amplifier, and a second differential amplification circuit whose input terminals at both ends are coupled to both ends of the power supply resistor and whose output terminal is coupled to one input terminal of the operational amplifier. According to the liquid discharge head unit of the aspect, by feeding back the voltage value obtained by multiplying an amplification rate of the second differential amplification circuit to the operational amplifier, it is possible to reduce the fluctuation in the current value taken out from the power supply circuit.

(16) The liquid discharge head unit of the aspect may further include a third detection resistor that is provided to correspond to a third piezoelectric element group, which is different from the first piezoelectric element group and the second piezoelectric element group among the plurality of piezoelectric elements, and is formed of the same material as the piezoelectric elements or the drive wiring. The switching circuit may be configured to switch to a third state in which the voltage detection circuit is configured to detect a voltage generated in the third detection resistor due to the current flowing from the power supply circuit.

(17) In the liquid discharge head unit of the aspect, an electric resistance value of the first detection resistor may be 0.5 to 1.5 times an electric resistance value of the second detection resistor. According to the liquid discharge head unit of the aspect, it is possible to reduce the measurement variation among the plurality of detection resistors by setting the electric resistance values of the plurality of detection resistors to substantially the same value.

(18) In the liquid discharge head unit of the aspect, a temperature of the pressure chamber may be acquired by using the voltage generated in the first detection resistor due to the current flowing from the power supply circuit, the voltage being detected by the voltage detection circuit, and a temperature of the pressure chamber may be acquired by using the voltage generated in the second detection resistor due to the current flowing from the power supply circuit, the voltage being detected by the voltage detection circuit. According to the liquid discharge head unit of the aspect, the temperature is acquired using the voltage values applied to the first detection resistor and the second detection resistor, so that it is possible to miniaturize the temperature detection circuit compared as a case where a thermocouple is used.

(19) The liquid discharge head unit of the aspect may further include a wiring substrate that is electrically coupled to the liquid discharge head. The switching circuit may be disposed at the wiring substrate. According to the liquid discharge head unit of the aspect, the switching circuit is disposed at the wiring substrate in the liquid discharge head unit, so that it is possible to shorten the wiring length from the first detection resistor and the second detection resistor to the switching circuit and it is possible to reduce noise when a detection result is transmitted, as compared with a case where the switching circuit is disposed at a place other than the liquid discharge head unit.

(20) According to another aspect of the present disclosure, there is provided a liquid discharge device. The liquid discharge device includes the liquid discharge head unit of the aspect, and a control section that controls a discharge operation of the liquid discharge head unit. According to the liquid discharge device, since the control section is provided outside the liquid discharge head unit, it is possible to reduce or suppress the influence of heat transfer and electrical noise from the control substrate on the temperature detection circuit.

The present disclosure can also be realized in various aspects other than the liquid discharge head unit and the liquid discharge device. For example, it is possible to realize the present disclosure with an aspect of a method for manufacturing a liquid discharge head unit, a method for manufacturing a liquid discharge device, or the like.

The present disclosure is not limited to an ink jet method, and can be applied to any liquid discharge devices that discharge a liquid other than ink and a liquid discharge head that is used in the liquid discharge devices. For example, the present disclosure can be applied to the following various liquid discharge devices and liquid discharge heads thereof.

(1) An image recording device such as a facsimile device.
(2) A color material discharge device used for manufacturing a color filter for an image display device such as a liquid crystal display.
(3) An electrode material discharge device used for forming electrodes of an organic Electro Luminescence (EL) display, a Field Emission Display (FED), or the like.
(4) A liquid discharge device that discharges a liquid containing a bioorganic substance used for manufacturing a biochip.
(5) A sample discharge device as a precision pipette.
(6) A lubricating oil discharge device.
(7) A resin liquid discharge device.
(8) A liquid discharge device that discharges lubricating oil with pinpoint to a precision machine such as a watch or a camera.
(9) A liquid discharge device that discharges a transparent resin liquid, such as an ultraviolet curable resin liquid, onto a substrate in order to form a micro hemispherical lens (optical lens) or the like used for an optical communication element or the like.
(10) A liquid discharge device that discharges an acidic or alkaline etching liquid for etching a substrate or the like.
(11) A liquid discharge device including a liquid consumption head that discharges any other minute amount of droplets.

The “droplet” refers to a state of the liquid discharged from the liquid discharge device, and includes those having a granular, tear-like, or thread-like tail. Further, the “liquid” referred to here may be any material that can be consumed by the liquid discharge device. For example, the “liquid” may be a material in a state when a substance is liquefied, and the “liquid” includes a liquid state material with high or low viscosity and a liquid state material, such as a sol, gel water, other inorganic solvent, organic solvent, solution, liquid resin, and liquid metal (metal melt). Further, the “liquid” includes not only a liquid as a state of a substance but also a liquid in which particles of a functional material made of a solid substance, such as a pigment or a metal particle, are dissolved, dispersed, or mixed in a solvent. Further, as a typical example of a combination of a first liquid and a second liquid, in addition to a combination of ink and reaction liquid as described in the embodiments, the following can be mentioned.

(1) Adhesive main agent and curing agent
(2) Paint-based paints and diluents, clear paints and diluents
(3) Main solvent and diluting solvent containing cells of ink for cells
(4) Metallic leaf pigment dispersion liquid and diluting solvent of ink (metallic ink) that develops metallic luster.
(5) Gasoline/diesel and biofuel for vehicle fuel
(6) Main ingredients and protective ingredients of medicine.
(7) Light Emitting Diode (LED) fluorescent material and encapsulant

What is claimed is:

1. A liquid discharge head unit comprising:
a liquid discharge head that has a plurality of pressure chambers, a plurality of piezoelectric elements, and a drive wiring for applying a voltage for driving the piezoelectric elements to the piezoelectric elements;
a first detection resistor that is provided to correspond to a first piezoelectric element group among the plurality of piezoelectric elements, and formed of the same material as the piezoelectric elements or the drive wiring;
a second detection resistor that is provided to correspond to a second piezoelectric element group different from the first piezoelectric element group among the plurality of piezoelectric elements, and formed of the same material as the piezoelectric elements or the drive wiring;
a power supply circuit that causes a current to flow through the first detection resistor and the second detection resistor;
a voltage detection circuit that detects a voltage; and
a switching circuit that is configured to switch between a first state in which the voltage detection circuit detects a voltage generated in the first detection resistor due to the current flowing from the power supply circuit and a second state in which the voltage detection circuit detects a voltage generated in the second detection resistor due to the current flowing from the power supply circuit.

2. The liquid discharge head unit according to claim 1, wherein
a plurality of the liquid discharge heads are provided,
the plurality of liquid discharge heads include a first liquid discharge head and a second liquid discharge head different from the first liquid discharge head,
the first detection resistor is provided in the first liquid discharge head, and
the second detection resistor is provided in the second liquid discharge head.

3. The liquid discharge head unit according to claim 1, wherein
the first detection resistor and the second detection resistor are provided in the liquid discharge head.

4. The liquid discharge head unit according to claim 1, further comprising:
a first route that electrically couples the power supply circuit and the voltage detection circuit via the first detection resistor;
a second route that electrically couples the power supply circuit and the voltage detection circuit via the second detection resistor;
a third route that electrically couples the power supply circuit and the voltage detection circuit without the first detection resistor; and
a fourth route that electrically couples the power supply circuit and the voltage detection circuit without the second detection resistor.

5. The liquid discharge head unit according to claim 4, further comprising:
a first switch provided between the first detection resistor and the voltage detection circuit in the middle of the first route; and
a second switch provided between the second detection resistor and the voltage detection circuit in the middle of the second route, wherein
the switching circuit switches to the first state by setting the first switch to a coupling state and setting the second switch to a cutoff state, and switches to the second state by setting the second switch to a coupling state and setting the first switch to a cutoff state.

6. The liquid discharge head unit according to claim 5, wherein
on-resistance of the first switch is equal to or less than 1/100 of an electric resistance value of the first detection resistor, and
on-resistance of the second switch is equal to or less than 1/100 of an electric resistance value of the second detection resistor.

7. The liquid discharge head unit according to claim 6, wherein
the third route and the fourth route are the same route.

8. The liquid discharge head unit according to claim 4, further comprising:
a third switch provided between a first branch point and the voltage detection circuit in the middle of the third route; and
a fourth switch provided between a second branch point and the voltage detection circuit in the middle of the fourth route, wherein
the first route and the third route are the same route from the power supply circuit to the first branch point and are different routes from the first branch point to the voltage detection circuit,
the second route and the fourth route are the same route from the power supply circuit to the second branch point and are different routes from the second branch point to the voltage detection circuit, and
the switching circuit switches to the first state by setting the third switch to a coupling state and setting the fourth switch to a cutoff state, and switches to the second state by setting the fourth switch to a coupling state and setting the third switch to a cutoff state.

9. The liquid discharge head unit according to claim 8, further comprising:
a fifth switch provided between the power supply circuit and the first branch point in the middle of the first route; and
a sixth switch provided between the power supply circuit and the second branch point in the middle of the second route, wherein
the switching circuit switches to the first state by setting the fifth switch to a coupling state and setting the sixth switch to a cutoff state, and switches to the second state by setting the sixth switch to a coupling state and setting the fifth switch to a cutoff state.

10. The liquid discharge head unit according to claim 9, wherein
the switching circuit interlocks the third switch and the fifth switch to switch between the coupling state and the cutoff state of the third switch and the fifth switch, and interlocks the fourth switch and the sixth switch to switch between the coupling state and the cutoff state of the fourth switch and the sixth switch.

11. The liquid discharge head unit according to claim 8, wherein
on-resistance of the third switch is equal to or less than 1/100 of an electric resistance value of the first detection resistor, and
on-resistance of the fourth switch is equal to or less than 1/100 of an electric resistance value of the second detection resistor.

12. The liquid discharge head unit according to claim 4, wherein
the voltage detection circuit includes
a first differential amplification circuit having one input terminal, to which the first route and the second route are coupled, and the other input terminal to which the third route and the fourth route are coupled, and
a fifth route that couples an output terminal of the first differential amplification circuit and an input terminal of the voltage detection circuit.

13. The liquid discharge head unit according to claim 1, wherein
the power supply circuit is a constant current circuit that causes a constant current to flow through the first detection resistor and the second detection resistor.

14. The liquid discharge head unit according to claim 1, further comprising:
a sixth route that electrically couples the voltage detection circuit and the power supply circuit to output a reference voltage of the voltage detection circuit, wherein
the power supply circuit takes out a current proportional to the reference voltage input via the sixth route.

15. The liquid discharge head unit according to claim 1, wherein
the power supply circuit includes an operational amplifier, a power supply resistor coupled to an output terminal of the operational amplifier, and a second differential amplification circuit whose input terminals at both ends are coupled to both ends of the power supply resistor and whose output terminal is coupled to one input terminal of the operational amplifier.

16. The liquid discharge head unit according to claim 1, further comprising:
a third detection resistor that is provided to correspond to a third piezoelectric element group, which is different from the first piezoelectric element group and the second piezoelectric element group among the plurality of piezoelectric elements, and is formed of the same material as the piezoelectric elements or the drive wiring, wherein
the switching circuit is configured to switch to a third state in which the voltage detection circuit is configured to detect a voltage generated in the third detection resistor due to the current flowing from the power supply circuit.

17. The liquid discharge head unit according to claim 1, wherein
an electric resistance value of the first detection resistor is 0.5 to 1.5 times an electric resistance value of the second detection resistor.

18. The liquid discharge head unit according to claim 1, wherein
a temperature of the pressure chamber is acquired by using the voltage generated in the first detection resistor due to the current flowing from the power supply circuit, the voltage being detected by the voltage detection circuit, and a temperature of the pressure chamber is acquired by using the voltage generated in the second detection resistor due to the current flowing from the power supply circuit, the voltage being detected by the voltage detection circuit.

19. The liquid discharge head unit according to claim 1, further comprising:
a wiring substrate that is electrically coupled to the liquid discharge head, wherein
the switching circuit is disposed at the wiring substrate.

20. A liquid discharge device comprising:
the liquid discharge head unit according to claim 1; and
a control section that controls a discharge operation of the liquid discharge head unit.
